(19) United States
(12) Patent Application Publication
(10) Pub. No.: US 2024/0010559 A1
(43) Pub. Date: Jan. 11, 2024

(54) COMPOSITION

(71) Applicant: SPHERA LIMITED, Stockton-on-Tees (GB)

(72) Inventors: Natasha Alice BOULDING, Stockton-on-Tees (GB); Philip Daniel BUCKLEY, Stockton-on-Tees (GB); Scott Peter BUSH, Stockton-on-Tees (GB)

(73) Assignee: LOW CARBON MATERIALS LIMITED, Stockton-on-Tees (GB)

(21) Appl. No.: 18/041,847

(22) PCT Filed: Aug. 18, 2021
(86) PCT No.: PCT/GB2021/052141

§ 371 Date: Feb. 16, 2023

(30) Foreign Application Priority Data
Aug. 18, 2020 (GB) 2012895.5

(51) Int. Cl. C04B 20/02; C04B 18/20; C04B 28/00

(52) U.S. Cl. CPC C04B 20/023; C04B 18/20; C04B 28/006

(57) ABSTRACT

There is a method of making an aggregate having plastics particles having sizes of about 0.1 cm to about 1 cm. The method has the step of treating a first plurality of plastics particles with low-pressure plasma and/or an electron beam to provide treated particles. The plasma has ions formed from any one selected from the group consisting of a carboxylic acid, alcohol, amine, ester, aldehyde, amide, ketone, epoxide, ammonia and peroxide and a combination of two or more thereof. The disclosure further relates to aggregates and their uses.

### CROSS-REFERENCE TO RELATED APPLICATIONS

The present application is a national stage entry claiming priority based on PCT Application No. PCT/GB2021/052141, filed Aug. 18, 2021, which claims priority based on Great Britain Application No. 2012895.5, filed Aug. 18, 2020, the disclosures of which are incorporated herein in their entireties.

### FIELD OF THE DISCLOSURE

The present disclosure concerns a method of making an aggregate comprising plastic particles having sizes of about 0.1 μm to about 1 cm, the method comprising treating a first plurality of plastic particles with low pressure plasma and/or an electron beam to provide treated particles. The disclosure also concerns an aggregate comprising such treated particles. Such aggregates may be useful as concrete additives or as natural aggregate (e.g. sand) replacements in concrete. Accordingly, the disclosure also provides concrete comprising the aggregate, a method of making such concrete and the use of the aggregate as a replacement for natural aggregate in concrete.

### BACKGROUND OF THE DISCLOSURE

Large quantities of plastic waste are produced each year and are disposed of in landfill, incinerated or recycled. Disposing plastic in landfill and incinerating plastic contributes to environmental pollution. Recycling plastic may simultaneously avoid environmental pollution and provide useful products.

One application of recycled plastic is in construction materials such as concrete or mortar (see F. Iucolano et al., Mater. Design, 2013, 52, 916-922; C. Makri, J. Hahladakis and E. Gidarakos, J. Hazard Mater., 2019, 379, 1-8; L. Cong et al., Constr. Build. Mater., 2019, 225, 1012-1025; M. Gómez et al., Constr. Build. Mater., 2020, 230, 116977, 1-11). Plastic may be used as an aggregate to replace the natural coarse or fine aggregate used in concrete, thereby producing lighter weight concrete (see for example S. Yang et al., Constr. Build. Mater., 2015, 84, 444-453; G-P. Zéhil and J. Assaad, Constr. Build. Mater., 2019, 226, 1-10; J. Ruiz-Herrero et al., Constr. Build. Mater., 2016, 104, 298-310; and J. Thorneycroft et al., Constr. Build. Mater., 2018, 161, 63-69). Alternatively, plastic may be used as a fibrous additive to reinforce concrete (L. Gu and T. Ozbakkaloglu, Waste Management, 2016, 51, 19-42; and C. Ince, Emerg. Mater. Res., 2019, 8(2), 265-274).

Use of waste plastic to replace the natural aggregate used in concrete is advantageous not only to recycle waste plastic, but also to avoid the use of natural aggregates, which are becoming scarce and more costly owing to their overuse (M. Ju, K. Park and W-J Park, Int. J. Concr. Struct. Mater., 2019, 13(61), 1-13). Replacement of natural aggregates with plastic is reported to produce lighter weight concrete with a lower compressive strength (L. Gu et al., supra). The lower compressive strength is attributed to a poorer bond between the plastic aggregate and the surrounding matrix in the concrete relative to natural aggregate. The loss in compressive strength may be limited by selecting plastic aggregate of specific size distribution and particle roughness. Plastic aggregates with a smooth surface and spherical shape are reported to produce concrete with a greater workability. However, plastic particles with a greater surface roughness are reported to interact more favourably with the cement matrix: surface roughness favours the anchoring of the plastic to the cement matrix (L. Gu et al., supra).

Natural aggregate typically comprises particles of non-uniform size and shape. J. Thorneycroft et al. (supra) report on the replacement of natural aggregate with plastic aggregate comprising particle sizes that are graded to include small and large particle sizes. It is theorised that aggregate comprising a larger size distribution of plastic particles achieves efficient packing of the particles within concrete. The strength of the concrete produced on replacement of 10% fine sand with polyethylene terephthalate (PET) aggregates of different size distributions was compared. It was found that the concrete produced using PET aggregate with a size distribution matching that of fine sand exhibited the greatest compressive and tensile strength.

The typically smooth and hydrophobic surfaces of plastic aggregate often lead to poor interactions with cement, and poor dispersion of the plastic throughout the concrete that forms. As greater amounts of natural aggregate are replaced with plastic aggregate, a poor morphology of the concrete results—the structure becomes overly porous, with voids forming around the plastic aggregate (S. Yang et al., supra).

Plastic particles within an aggregate may be surface-modified to improve interaction of the aggregate with cement. Surface modification may be achieved by exposing the particles to chemicals, gamma irradiation, electron beams or plasma.

Surface modification via chemical treatment typically results in the binding of new chemical groups at the surface of the particle. Washing particles with a combination of bleach and sodium hydroxide (J. Thorneycroft et al., supra; T. Naik et al., Cement Concrete Res., 1996, 26(10), 1489-1492) is an example of surface modification by chemical treatment. It is theorized that such treatment leads to the formation of oxy and carboxylate groups at the surface of particles, and that these groups are able to participate in cementitious reactions such as the pozzolanic reaction (described below). Consequently, the particles are able to interact with cement and this improves the structure and strength of the concrete that results.

Gamma radiation or electron beams may be used to induce graft copolymerisation of polar monomers such as methyl acrylate, acrylic acid, acrylonitrile and N-vinylpyrollidone to the surfaces of plastic particles (see L. Ma, M. Wang and X. Ge, Radiat. Phys. Chem., 2013, 90, 92-97 for the use of gamma radiation to induce graft copolymerisation and see C. He and Z. Gu, J. Appl. Polym., 2003, 89, 3931-3938 and S. C. Lapin, UV+EB Technology, 2015, 1, 44-49 for the use of electron beams to induce graft copolymerisation). On exposure to gamma radiation or electron beams, free radicals may form at the surface of the plastic, which may copolymerise with monomers, resulting in monomer chains grafted to the surface of the plastic. Alternatively, free radicals may react with oxygen in the air, resulting in the formation of polar functional groups such as oxy groups. Plastic that has been surface-modified in this way may be contacted with cement. Polar chains and functional groups may interact more favourably with cement, improving the structure and strength of concrete that is formed. In addition, gamma radiation or electron beams may be used to modify the topography of plastic by removing material, cross-linking polymer chains or causing the scission of polymer chains. As a result, a plastic's surface may be rougher and more adhesive, allowing the plastic to interact more favourably with cement and produce concrete with a less porous structure and greater strength (A. Martínez et al., Constr. Build. Mater., 2019, 201, 778-785; G. Martínez-Barrera et al., Evolution of Ionizing Radiation Research, Chapter 11, Gamma Radiation as a Recycling Tool for Waste Materials Used in Concrete, 2015, 259-279; C. Schaefer et al., Waste Manage., 2018, 71, 426-439; A. A. El-Saftawy, et al., Radiat. Phys. Chem., 2014, 102, 96-102).

Binding new chemical groups to the surfaces of plastic particles may also be achieved via plasma treatment. Plasma may react with and bind to the plastic at the surface of the particle. Typically, treatment is carried out at atmospheric pressure and plasma is formed by ionising gases, often using a dielectric barrier discharge (see J. Grace and L. Gerenser, J. Disper. Sci. Technol., 2003, 24, 3 & 4, 305-341). Often plasma treatment is carried out using oxygen, nitrogen, ammonia, water vapour, carbon dioxide or air, and the plasma produced on ionising these gases may bind to the surfaces of plastic particles. When hydrophilic plasmas are used, the surfaces of plastic particles become bound to hydrophilic groups. The hydrophilic surfaces may interact more favourably with cement, thus improving the structure and strength of the concrete that results (C. Zhang, V. Gopalaratnam and H. Yasuda, J. Appl. Polym., 2000, 76(14), 1985-1996; and T. Morávek, J. Ráhel and Z. Szalay, WDS'13 Proc. Contrib. Pap. Part III, MATFYZPRESS, 2013, 161-164.). In addition, plasma treatment has been reported to alter the topography of plastic by removing material. This may cause pores to form at the surface of the plastic, which may improve the adhesive properties of the plastic (A. Yáñez-Pacios and J. Martín-Martínez, Surf. Topogt.: Metrol. Prop., 2018, 6, 034020).

In U.S. Pat. No. 6,000,877 A, WO 02/053646 A1, and WO 97/17405 A1 (Plasphalt Project Ltd. Co.) an asphaltic paving material is described comprising plastic particles that are surface activated by methods that include plasma treatment. In WO 2016/084007 A1 (MNZ Holdings Ltd.), a plastic aggregate for use in concrete is described. It is mentioned that the particles of the aggregate may be plasma treated, specifically flame-treated. The use of oxygen plasma to bind hydroxy groups onto microspheres is described in WO 2014/120172 A1 (Empire Technology Dev. LLC). The hydroxy groups are reacted further with methacrylic chloride to covalently bind a layer of methacrylate moieties to the surface of the polymeric microspheres. The use of low-pressure plasma or an electron beam to modify the surfaces of plastic particles is not described in any of these patent documents.

Atmospheric plasma treatment is limited to ionising chemicals that are gases at atmospheric pressures, which in turn limits the types of plasma generated. Low-pressure plasma treatments may be used as an alternative. In low-pressure plasma treatments, a reaction chamber is evacuated to pressures lower than atmospheric pressure, at which pressures the plasma source of interest becomes gaseous. The plasma source is ionised to produce a flow of low pressure plasma through the chamber (A. Yáñez-Pacios and J. Martín-Martínez, supra; L. Gerenser, J. Adhesion Sci. Technol., 1987, 1(4), 303-318; L. Gerenser, J, Adhesion Sci. Technol., 1993, 7(10), 597-614; R. Foerch, J. Izawa and G. Spears, J. Adhesion Sci. Technol., 1991, 5(7), 549-564; and E. Occhiello et al., J. Appl. Polym. Sci., 1991, 42(2), 551-559). The low-pressure plasma treatments described in the above-referenced papers have been used to modify the surfaces of bulk plastic substrates and plastic films with plasmas derived from chemicals that are gaseous at atmospheric pressure.

In WO 2007/026167 A1 (Haydale Ltd.), low-pressure plasma derived from air is described as being useful to treat particulate rubber and in US 2013320274 A1 (also Haydale Ltd.), low-pressure plasma derived from oxygen is described as useful to treat graphite particles or agglomerates of carbon nanoparticles. The use of atmospheric gases is considered to be highly convenient.

To improve the dispersion of plastic in cement, and subsequently concrete, it is desirable to controllably modify the surfaces of plastic particles within an aggregate. The present disclosure seeks to address this.

### SUMMARY OF THE DISCLOSURE

The present disclosure provides aggregates of plastic particles having sizes of about 0.1 μm to about 1 cm, obtainable by treatment with low pressure plasma and/or an electron beam. Such methods of treatment advantageously allow the surfaces of plastic particles to be controllably modified. Furthermore, the use of low-pressure plasma provides benefits over the use atmospheric plasma: a wide variety of plasma sources may be used to modify the surfaces of the plastic particles, including sources that are liquid at atmospheric pressure and would not be suitable for use in atmospheric plasma treatment. In addition, the use of low-pressure plasma treatment allows plasma sources to be selectively ionised to produce specific plasmas, and allows plasmas to be controllably flowed through the reaction chamber.

Viewed from a first aspect, the present disclosure provides a method of making an aggregate comprising plastic particles having sizes of about 0.1 μm to about 1 cm, the method comprising treating a first plurality of plastic particles with low pressure plasma and/or an electron beam to provide treated particles, wherein the plasma comprises ions formed from any one selected from the group consisting of a carboxylic acid, alcohol, amine, ester, aldehyde, amide, ketone, epoxide, ammonia and peroxide or a combination of two or more thereof.

Viewed from a second aspect, the present disclosure provides an aggregate obtainable by the method of the first aspect.

Viewed from a third aspect, the present disclosure provides an aggregate comprising plastic particles of about 0.1 μm to about 1 cm, wherein at least some particles of the aggregate comprise surfaces comprising pendant groups selected from any one of or a combination of two or more of carboxyl, alkoxy, hydroxyl, amino, imido alkylidene, ester, aldehydo, acyl, amido, keto, epoxy and peroxide groups, wherein the at least some particles have been treated with a) an electron beam, or b) low-pressure plasma.

The aggregates of the disclosure may be useful as concrete additives or as natural aggregate (e.g. sand) replacements in concrete. Accordingly, the disclosure also provides concrete comprising the aggregate, a method of making such concrete and use of the aggregate as a replacement for natural aggregate (e.g. sand) in concrete.

Therefore, viewed from a fourth aspect the present disclosure provides concrete comprising the aggregate of the second or third aspect.

Viewed from a fifth aspect, the disclosure provides a method of making concrete comprising contacting the aggregate of the second or third aspect with cement.

Viewed from a sixth aspect, the disclosure provides use of the aggregate of the second or third aspect as a replacement for natural aggregate (e.g. sand) in concrete.

Further aspects and embodiments of the present disclosure will be evident from the discussion that follows below.

### BRIEF DESCRIPTION OF THE FIGURES

FIG. 1 is a plot of the percentage of the particles of sharp sand collected through sieves as a function of sieve size. The line shape indicates the size distribution of the particles within sharp sand.

FIG. 2 is a plot of the percentage of the particles of builders sand collected through sieves as a function of sieve size. The line shape indicates the size distribution of the particles within builders sand.

FIG. 3 is a plot of the percentage of the particles of plasters sand collected through sieves as a function of sieve size. The line shape indicates the size distribution of the particles within plasters sand.

FIG. 4 is a plot of the percentage of the particles of sharp sand, builders sand and plasters sand collected through sieves as a function of sieve size. The size distribution of the particles within sharp sand, builders sand and plasters sand are compared.

FIG. 5 is a plot of the percentage of the particles of sharp sand and size-matched polyethylene particles collected through sieves as a function of sieve size. The size distribution of the particles within sharp sand and within size-matched polyethylene are compared.

FIG. 6 is a photograph of concrete samples P1 to P4 on removal from their moulds.

FIG. 7 is a plot of the compressional strengths of concrete samples P1 to P4 at 3,7 and 28 days after their preparation. The error bars represent standard error.

FIG. 8 is a plot of the compressional strength of concrete samples P4 (dark line) and P2 (light line) as a function of the number of days following sample preparation. The axis intercepts highlight the greater curing time of sample P2 with respect to sample P4.

FIG. 9 is a plot of the compressional strength of concrete samples P7 and P8 at 7 days after their preparation. The error bars represent standard error.

FIG. 10 is a comparison of the static water contact angle for PE, PU, PET, PEX and SB before and after plasma treatment with AA, EDA, DMF and CP.

FIG. 11 is a comparison of the static water contact angle for PVC, PE and PP before and after electron beam treatment at 80 keV power and 450 kGy dosage.

FIG. 12 represents the XPS spectra for 4 points (carbon and oxygen) on the untreated PE surface (top 2 images) and 4 points (carbon and oxygen) on the treated PE surface (bottom 2 images).

FIG. 13. The percentage compressional strength gain of concrete cubes containing plasma treated plastic particles compared to concrete containing untreated plastic particles.

FIG. 14. The percentage compressional strength gain of concrete cubes containing plasma treated (AA) plastic particles compared to concrete containing untreated plastic particles after 3, 7 and 28 days.

FIG. 15. The percentage compressional strength gain of concrete cubes containing plasma treated PE plastic particles with AA as an additive compared to concrete containing no plastic.

FIG. 16. SEM images of PE.

### DETAILED DESCRIPTION OF THE DISCLOSURE

The method of the disclosure allows for controllable modification of the surfaces of plastic particles within an aggregate.

In the discussion that follows, reference is made to a number of terms, which are to be understood to have the meanings provided below, unless a context expressly indicates to the contrary. The nomenclature used herein for defining compounds, in particular the compounds described herein, is intended to be in accordance with the rules of the International Union of Pure and Applied Chemistry (IUPAC) for chemical compounds, specifically the “IUPAC Compendium of Chemical Terminology (Gold Book)” (see A. D. Jenkins et al., Pure & Appl. Chem., 1996, 68, 2287-2311). For the avoidance of doubt, if a rule of the IUPAC organisation is contrary to a definition provided herein, the definition herein is to prevail.

The term “comprising” or variants thereof will be understood to imply the inclusion of a stated element, integer or step, or group of elements, integers or steps, but not the exclusion of any other element, integer or step, or group of elements, integers or steps.

The term “consisting” or variants thereof is to be understood to imply the inclusion of a stated element, integer or step, or group of elements, integers or steps, and the exclusion of any other element, integer or step or group of elements, integers or steps.

The term “about” herein, when qualifying a number or value, is used to refer to values that lie within ±5% of the value specified. For example, if a particle size range is specified to be about 60 μm to about 4 mm, particle sizes of 57 μm to 4.2 mm are included.

Atmospheric pressure refers to a pressure of about 1 atm, or 1.013 bar (101.3 kPa).

The term “granulating” refers to forming into particles, i.e. discrete, solid pieces, and may be achieved by shredding (tearing or cutting), milling (pressing, crushing and/or grinding) and chipping (breaking off pieces).

The low-pressure plasma of the disclosure comprises ions formed from any one selected from the group consisting of a carboxylic acid, alcohol, amine, ester, aldehyde, amide, ketone, epoxide, ammonia and peroxide or a combination of two or more thereof, preferably carboxylic acid, alcohol, amine, ester, aldehyde, amide, ketone, and ammonia. These plasma sources are all capable of forming hydrophilic groups at the surfaces of the plastic particles. The term “hydrophilic” is well known in the art and refers to the capacity of a molecular entity to interact with polar solvents, in particular with water. Hydrophilic groups may also be referred to as polar groups. Hydrophilic groups include carboxyl, alkoxy, hydroxyl, amino, imido alkylidene, ester, aldehydo, acyl, amido, keto, epoxy and peroxide groups.

As described above, the use of low-pressure plasma treatment allows plasma sources to be ionised selectively to produce specific plasmas, and allows plasmas to flow controllably through the reaction chamber. The ions that may be formed via selective ionisation of the plasma sources of the first aspect are now described.

A carboxylic acid is a group of formula RC(O)OH, where R is typically hydrocarbyl. When used as part of a plasma source, the resultant carboxylic acid ions may react at the surfaces of the plastic particles. One or more bonds may form between the surface of a plastic particle and one or more atoms of R (e.g. the carbon atoms of a hydrocarbyl) or the carbon atom of the carboxyl group of the carboxylic acid ions, resulting in the formation of carboxyl groups —RC(O)OH, and/or —C(O)OH, and/or ester groups —O(O)CR at the surface of the plastic particle.

An alcohol is a group of formula ROH, where R is typically hydrocarbyl. When used as part of a plasma source, one or more bonds may form between the surface of a plastic particle and one or more atoms of R (e.g. the carbon atoms of a hydrocarbyl) or the oxygen atom of the hydroxy group of the alcohol ions, resulting in the formation of hydroxyl groups —ROH and/or alkoxy groups —OR at the surface of the plastic particle.

An amine is a group of formula NR₃, where typically at least one R is hydrocarbyl and the other two R groups are each independently a hydrocarbyl or a proton. When used as part of a plasma source, one or more bonds may form between the surface of a plastic particle and one or more atoms of the R groups (e.g. the carbon atoms of a hydrocarbyl) or the nitrogen atom of the amine, resulting in the formation of amino groups —RNR₂, —NR₂ and/or imido alkylidene groups=NR at the surface of the plastic particle. Typically, at least one R of the amino and imido alkylidene groups is hydrocarbyl.

An ester is a group of formula R(O)OR, where each R is typically hydrocarbyl. When used as part of a plasma source, one or more bonds may form between the surface of a plastic particle and one or more atoms of the R groups (e.g. the carbon atoms of a hydrocarbyl), resulting in the formation of ester groups —RO(O)R and/or —R(O)OR at the surface of the plastic particle.

An aldehyde is a group of formula RC(O)H, where R is typically hydrocarbyl or proton. When used as part of a plasma source, one or more bonds may form between the surface of a plastic particle and one or more atoms of the R group (e.g. the carbon atoms of a hydrocarbyl) or the carbon atom of the carbonyl, resulting in the formation of aldehydo groups —RC(O)H and/or acyl groups —(O)CR at the surface of the plastic particle.

An amide is a group of formula RC(O)NR₂, where typically each R is independently a hydrocarbyl or a proton. When used as part of a plasma source, one or more bonds may form between the surface of a plastic particle and one or more atoms of the R group (e.g. the carbon atoms of a hydrocarbyl) or the carbon atom of the carbonyl, or the nitrogen atom of the amido, resulting in the formation of amido groups —RC(O)NR₂, —C(O)NR₂, —R(R)N(O)CR and/or —(R)N(O)CR at the surface of the plastic particle.

A ketone is a group of formula RC(O)R, where each R is typically hydrocarbyl. When used as part of a plasma source, one or more bonds may form between the surface of a plastic particle and one or more atoms of the R group (e.g. the carbon atoms of a hydrocarbyl), resulting in the formation of keto groups —RC(O)R at the surface of the plastic particle.

An epoxide is a group of formula R₂COCR₂, where each R is typically independently a proton or hydrocarbyl. When used as part of a plasma source, one or more bonds may form between the surface of a plastic particle and one or more atoms of the R group (e.g. the carbon atoms of a hydrocarbyl) or the carbon atoms of the epoxide resulting in the formation of epoxy groups —R(R)COCR₂ and/or hydroxyl groups —(R₂)CC(OH)(R₂) at the surface of the plastic particle.

Ammonia is of formula NH₃. When used as part of a plasma source, one or more bonds may form between the surface of a plastic particle and the nitrogen atom of ammonia, resulting in the formation of —NH₂, ═NH and/or ≡N at the surface of the plastic particle.

A peroxide is a group of formula R—O—O—R, where each R is typically independently a hydrocarbyl or a proton. When used as part of a plasma source, one or more bonds may form between the surface of a plastic particle and one or more atoms of the R groups (e.g. the carbon atoms of a hydrocarbyl) or an oxygen atom of the peroxide ion, resulting in the formation of peroxide groups —R—O—O—R and/or —O—O—R at the surface of the plastic particle.

The term “hydrocarbyl” defines univalent groups derived from hydrocarbons by removal of a hydrogen atom from any carbon atom, wherein the term “hydrocarbon” refers to compounds consisting of hydrogen and carbon only.

A hydrocarbyl may be an “alkyl”, which term is well known in the art and defines univalent groups derived from alkanes by removal of a hydrogen atom from any carbon atom, wherein the term “alkane” is intended to define acyclic branched or unbranched hydrocarbons having the general formula CₙH₂ₙ₊₂, wherein n is an integer

The term “pendant”, is used herein to define the location of chemical entities, such as hydrophilic groups, and refers to groups that are located at the outer surface of the plastic particles and protrude away from the outer surface. The outer surface refers to the surface of the plastic particle that is oriented away from the centre of the plastic particle.

“Thermosetting polymer” refers to a polymer, which on curing, irreversibly forms an infusible, insoluble polymer network known as a thermoset.

“Thermoplastic polymer” refers to a polymer that reversibly forms a polymer network. On heating a thermoplastic polymer, the solid network may become pliable or moldable and may set into a solid form on cooling.

The term “aggregate” is used herein to refer to particulate material. The term “natural aggregate” encompasses aggregates formed from natural materials such as sand, gravel or crushed stone. “Gravel” and “crushed rock” refer to particulate rocks and minerals, often limestone, of sizes of about greater than 5 mm. Gravel is typically size reduced by nature i.e. natural weathering. Crushed stone is typically size reduced artificially using machinery to break down big rocks/stones. “Sand” refers to particulate rocks and minerals, often comprising silica (SiO₂), of sizes of about 60 μm to about 5 mm. Commercial sand is available in many different varieties including sharp sand, builders sand, and plaster sand.

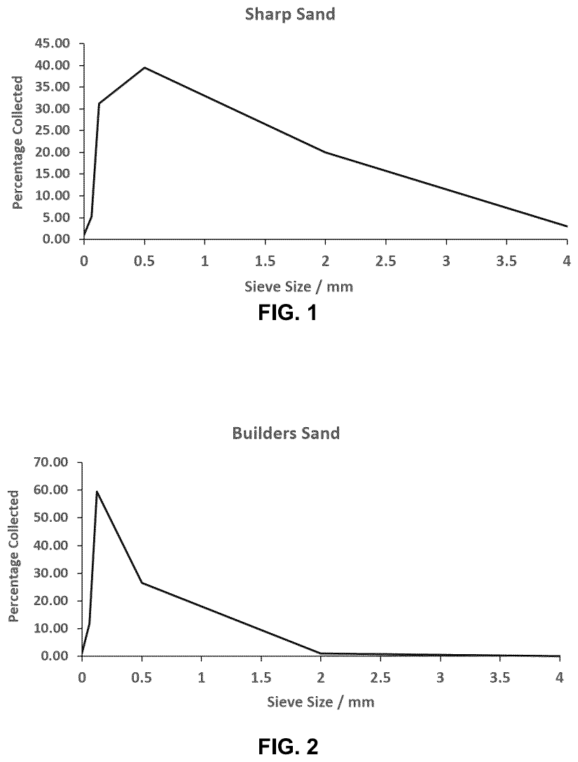

Sharp sand comprises angular particles leading to a coarse texture. It may be mixed with cement to form concrete or mortar of high strength, which are often used in construction. The size range and size distribution of the particles within sharp sand is not consistently defined in the art. However, it is to be understood that reference herein to a size distribution of sharp sand, or features thereof such as the particle size range or the modal particle size, refer to the size distribution and features thereof shown in FIG. 1 and tabulated in Table 2. For example, a particle size range of about 60 μm to about 4 mm is in line with the particle size range of sharp sand, and a modal particle size of about 125 μm to about 2 mm encompasses the modal particle size of sharp sand.

Builders sand and plastering sand comprise smooth particles leading to a fine structure. Builders sand and plaster sand may be mixed with cement to form concrete or mortar of low strength but high flexibility. Compositions comprising cement and builders sand are often used in bricklaying, whilst compositions comprising cement and plaster sand are often used in rendering (typically of external and internal walls) and plastering.

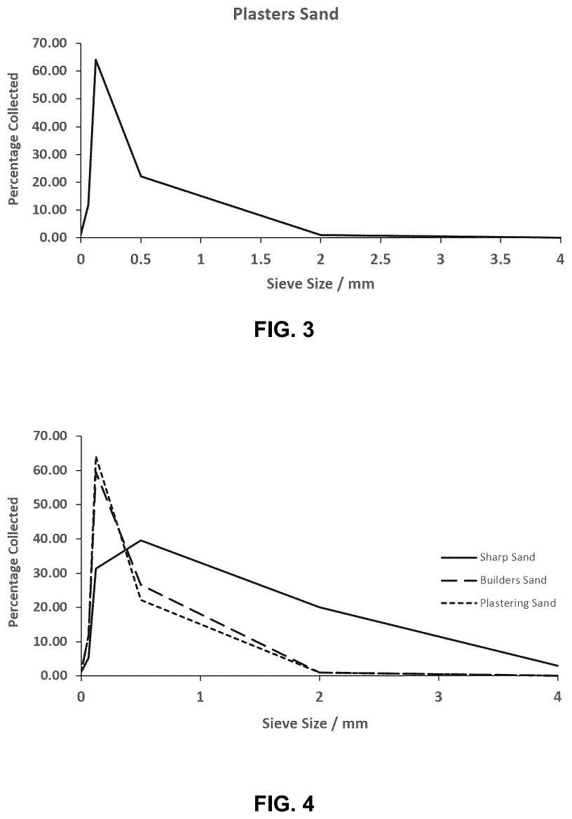

As with sharp sand, the size range and size distribution of the particles within builders sand and plaster sand is not consistently defined in the art. It is to be understood that reference herein to a size distribution of builders sand or plaster sand, or features thereof such as the particle size range or the modal particle size, refer to the size distribution and features thereof shown in FIG. 2 and FIG. 3, respectively, and tabulated in Table 2. For example, a particle size range of about 60 μm to about 2 mm is in line with the particle size range of builders sand and plaster sand, and a modal particle size of about 60 μm to about 0.5 mm encompasses the modal particle size of builders sand and plaster sand.

The aggregate of the disclosure is obtainable by treating a first plurality of plastic particles with low-pressure plasma and/or an electron beam to provide treated particles. Low-pressure plasma is a term of the art and refers to plasma at any pressure lower than atmospheric pressure. In low-pressure plasma treatments, a reaction chamber is evacuated to pressures lower than atmospheric pressure, at which pressures the plasma source of interest becomes gaseous. The plasma source is then ionised to produce low-pressure plasma. Ionisation is typically achieved by exposing the plasma source to an electric field, often generated between electrodes. Electrodeless plasma excitation methods are also known and may alternatively be used. In these, electromagnetic waves or changing magnetic fields are typically used to ionise the plasma source.

Typically, the first plurality of particles are introduced into a reaction chamber, the reaction chamber is sealed and the particles are subject to plasma treatment by generating plasma inside the reaction chamber. Often, electrodes are used to ionise the plasma source and are positioned at opposing positions in relation to the interior space of the reaction chamber.

An evacuation port may be provided for evacuation of the reaction chamber, and may be connected to an evacuation means such as a vacuum pump via a suitable filter. The pore size of the filter is such that the first plurality of particles remain in the reaction chamber. Typically, HEPA filters, ceramic, glass or sintered filters are suitable.

Application of vacuum is typically combined with a feed of gas for plasma formation. Gas flow is controllable and, if necessary, gas may be removed during treatment through a suitable filter.

Often, the first plurality of particles occupies less than 50% of the available volume in the reaction chamber. The low-pressure plasma is usually at a pressure of about 0.001 mbar (0.1 Pa) to about 500 mbar (50 kPa), about 0.001 mbar (0.1 Pa) to about 300 mbar (30 kPa) or about 0.01 mbar (10 Pa) to about 100 mbar (10 kPa). Typically, the low-pressure plasma is at a pressure of about 0.01 mbar (10 Pa) to about 10 mbar (1 kPa).

Once the low-pressure plasma is produced, it is made to flow over the first plurality of particles at a controllable rate. The flow rate of the low-pressure plasma is often about 5 to about 1000 SCCM, about 5 to about 800 SCCM, or about 10 to about 500 SCCM. Typically, the flow rate of the low-pressure plasma is about 10 to about 500 SCCM.

Plasma reactors suitable for low-pressure plasma treatment of particles include static bed, moving bed (barrel reactor) and fluidised bed reactors. When treating particles with plasma, reactors that agitate the particles are typically preferred. This is because particles are prone to aggregation, preventing the entire surface of the particle from being exposed to the low-pressure plasma. Consequently, barrel or fluidised bed reactors are often used to expose particles to plasma. Barrel reactors are able to move, thereby agitating the particles inside. Typically, the barrel reactor is cylindrical and moves by rotation of the cylinder about the length axis. In fluidised bed reactors, particles are suspended using high-pressure gases, which are typically pulsed thereby agitating the particles. Barrel reactors often give rise to more efficient plasma treatment of particles than fluidised bed reactors (see H. Abourayana et al., J. Miner., 2015, 1, 57-64), thus barrel reactors are often preferred.

The wall of the reactor may comprise paddles, vanes, baffles, recesses, scoops or the like which are shaped and dimensioned so that, during treatment, particles are lifted from a lower region of the reaction chamber and released to fall, often in the path of the plasma flow.

It is well known that exposure of substances to plasma for a longer duration leads to a greater degree of surface modification and the skilled person is capable of identifying suitable low-pressure plasma treatment times. Often, however, when the first plurality of particles is treated with low-pressure plasma, treatment is for a duration of about 1 seconds to about 2 hours, about 2 seconds to about 1 hour, or about 5 seconds to about minutes. Typically, treatment is for a duration of about 10 seconds to about 15 minutes.

It may be beneficial to apply heat to plasma sources to promote gasification.

However, plasmas at a temperature of about or greater than the melting temperature of the plastic particles may melt or alter the surface of the first plurality of particles in a detrimental way. Thus, plasma sources at elevated temperatures may be beneficial, but temperatures of about or greater than the melting temperature of the plastic particles are often avoided. Typically, heat is not purposely applied to the plasma source to promote gasification, i.e. low-pressure plasma treatment is typically carried out at ambient temperature, often at about 15° C. to about 30° C. Although heat is typically not purposefully applied, it may be generated as a by-product of ionisation of the plasma source. The generation of such heat is not excluded from methods of low-pressure plasma treatment in which heat is not purposely applied.

In electron beam treatment, electrons are emitted from heated cathodes, focussed into a beam with an extraction electrode, and accelerated in a vacuum by a strong electric field. The final energy of the electron beam depends on the accelerator used. For the purpose of surface modification, low-energy, self-shielded units often provide electron beams with suitable kinetic energy, typically in the range of 80 to 300 keV (S. Lapin, UV+EB Technology, 2015, 1). As described above, electron beams may be used to induce graft copolymerisation of polar monomers to the surfaces of plastic particles. In addition, or alternatively, electron beams may modify the topography of plastic by cross-linking polymer chains or causing the scission of polymer chains (see D. Manas et al., Polymers, 2018, 10, 158, 1-22). As a result, a plastic's surface may be rougher and more adhesive, allowing the plastic to interact more favourably with cement.

As with plasma treatment, reactors that agitate the first plurality of particles are typically preferred for use in electron beam treatment. Consequently, agitated or fluidised bed reactors are often used to expose particles to electron beams. If the first plurality of particles is treated with an electron beam, it is preferably treated in an agitated bed reactor. The skilled person is capable of identifying suitable electron beam doses. Often, however, dose ranges are about 30 kGy to about 900 kGy, about 30 kGy to about 500 kGy, or about 80 kGy to about 200 kGy. Typically, dose ranges are about 80 kGy to about 200 kGy.

The first plurality of particles may be treated with low-pressure plasma and an electron beam. Where both methods of treatment are used, the first plurality of particles is typically treated first with an electron beam and then with low-pressure plasma.

The aggregate of the disclosure comprises plastic particles of about 0.1 μm to about 1 cm. It is to be understood that the size range given refers to the longest dimension of the plastic particles. At least some of the particles of the aggregate are of sizes that fall within the size range. For example, some of the particles of the aggregate may have sizes of about 100 μm and the rest of the particles of the aggregate may have sizes greater than about 1 cm. According to particular embodiments, substantially all (more than 90% by weight, often more than 95% by weight, for example more than 98% or 99% by weight) of the plastic particles in the aggregate are of a size from of about 0.1 μm to about 1 cm.

Particles may be similarly sized or of different sizes. In some embodiments, the first plurality of particles are of different sizes and/or treated particles of different sizes are contacted with one another. Usually, contacting entails combining and often mixing the particles. Often, the first plurality of particles are of different sizes or treated particles of different sizes are contacted with one another. A first plurality of differently sized particles may be treated with low-pressure plasma and/or an electron beam to provide treated particles of different sizes. Alternatively, a first plurality of similarly sized particles may be treated with low-pressure plasma and/or an electron beam and then contacted with other treated particles of different sizes to provide treated particles of different sizes. In both cases, the aggregate comprises treated particles of different sizes.

Herein, particles are to be regarded as being of different sizes when their longest dimensions differ by more than 5%. For example, if a first particle has a longest dimension of 0.5 mm and a second particle has a longest dimension of 0.48 mm, the two particles differ in longest dimension by 5% or less, and are considered herein to be of similar sizes. Conversely, if a first particle has a longest dimension of 0.5 mm and a second particle has a longest dimension of 0.53 mm, the two particles differ in longest dimension by more than 5%, and are considered herein to be of different sizes.

Often, the first plurality of particles comprises particles of different sizes. Sometimes, the sizes of the first plurality of particles differ by more than 10%, 20%, 30%, 40% or 50%.

In some embodiments, the method of the disclosure further comprises separating a second plurality of plastic particles to provide separated particles, some of which are combined to provide the first plurality of particles of different sizes. Typically, the second plurality of particles are separated by longest dimension into size categories. Preferred quantities of particles of each size may then be contacted to provide the first plurality of particles of different sizes. Accordingly, the first plurality of particles typically has a different size distribution to the second plurality of particles, typically differing by particle size range and/or modal particle size.

In some embodiments, the second plurality of particles is separated by size using particle sieves of different mesh size. The skilled person is able to determine which mesh sizes are appropriate to use for the size range covered by one size category. For example, if it is preferable to separate the second plurality of particles by longest dimension into size categories of <63 μm, >63 μm to <125 μm, >125 μm to <250 μm, >250 μm to <500 μm, >500 μm to <2 mm, >2 mm to <4 mm, then mesh sizes of No. 230, 120, 60, 35, 10 and 5 should be used. The second plurality of particles may be separated by sieving in order of increasing or decreasing mesh size. Typically, the second plurality of particles is separated by sieving through particle sieves of decreasing mesh size (increasing mesh size No.).

In some embodiments, the second plurality of particles is prepared by granulating plastic of larger size. It is to be understood that plastic of larger size refers to bulk plastic, i.e. large pieces of plastic such as plastic sheeting, as well as plastic particles that are of larger size than those within the second plurality of particles. Alternatively, if the first plurality of particles is not provided by combining some of the separated particles from a second plurality of particles, then the first plurality of particles may be prepared by granulating plastic of larger size. In this case, plastic of larger size refers to bulk plastic, as well as plastic particles that are of larger size than those within the first plurality of particles.

Granulating may be achieved by any method that reduces the size of the plastic of larger size and forms it into particles. Granulating may be carried out by any one or a combination of shredding, milling and chipping. In some embodiments, granulating comprises shredding. In another embodiment, granulating comprises shredding and milling. Typically, granulating comprises shredding followed by milling. The surface texture of the particles in the first and second plurality of particles is dependent on the method used to granulate the plastic of larger size. Rougher surfaces are reported to produce better adhesive properties, thus granulating methods that produce more textured surfaces are preferred. Typically, excessive milling of the plastic of larger size is avoided as it may smooth the surfaces of the resulting plurality of particles to an undesirable extent.

In some embodiments, the first plurality of particles is treated with low-pressure plasma. As described above, low-pressure plasma able to react with and bind to the surface of plastic.

The low-pressure plasma comprises ions formed from any one selected from the group consisting of a carboxylic acid, alcohol, amine, ammonia, ester, aldehyde, amide, ketone, epoxide and peroxide, or a combination of two or more thereof. In some embodiments, the low-pressure plasma reacts with the particles to form pendant hydrophilic groups. When hydrophilic plasmas are used, the surfaces of plastic particles become bound to hydrophilic groups, which may interact more favourably with cement, thus improving the structure and strength of the concrete that may be prepared by doing so. This is described in more detail below.

Where the cement comprises calcium hydroxide and silicic acid, these constituents may react in a pozzolanic reaction to produce calcium silicate hydrate, which comprises hydroxy groups bound to calcium and silicon ions. Silicic acid is an example of a pozzolan, which is a material capable of binding to calcium hydroxide in the presence of water. The reaction of cement with water via such pozzolanic reactions within a concrete mixture leads to curing of the concrete. Concrete curing is also referred to as hydration of concrete.

Hydrophilic groups at the surfaces of plastic particles, such as carboxy groups, may react with calcium silicate hydrate or calcium hydroxide and displace the hydroxy groups at the calcium or silicon ions, thereby forming bonds between the hydrophilic groups at the surfaces of the plastic particles and the calcium silicate hydrate or calcium hydroxide. Thus, hydrophilic groups at the surfaces of plastic particles may act as pozzolans, increasing the rate of concrete curing and allowing the plastic particles to disperse throughout the cement with improvement of the structure and strength of the concrete that forms. Such improvements have been described by Z. Pan et al. in Cem. Concr. Compos., 2015, 58, 140-147, in which the introduction of 0.05 wt % graphene oxide (comprising pendant hydroxy and carboxy groups) into Portland cement was found to enhance the compressive and flexural strength of the cement.

In some embodiments, the low-pressure plasma comprises ions formed from any one selected from the group consisting of a carboxylic acid, ester, aldehyde, amide, ketone, and epoxide, or a combination of two or more thereof.

One of the benefits of treating the first plurality of particles with low-pressure plasma rather than plasma at atmospheric pressure is that a wider variety of plasma sources may be used including sources that are liquid at atmospheric pressure. In some embodiments, the low-pressure plasma comprises ions formed from precursors that are liquid at atmospheric pressure and a temperature of 20° C. Such precursors include any one or a combination of two or more of precursors selected from the group consisting of a carboxylic acid, alcohol, C_{≥3}amine, ester, C_{≥2} aldehyde, amide, ketone, C_{≥3}epoxide and peroxide. The low-pressure plasma may comprise ions formed from any one selected from the group consisting of a carboxylic acid, alcohol, C₃₋₆amine, ester, C₂₋₆aldehyde, amide, ketone, C₃₋₆epoxide and peroxide, or a combination of two or more thereof. Often, the low-pressure plasma precursor comprises no more than 6 carbon atoms. Thus, the low-pressure plasma often comprises ions formed from any one selected from the group consisting of a C₁₋₆carboxylic acid, C₁₋₆alcohol, C₃₋₆amine, C₁₋₆ester, C₂₋₆aldehyde, C₁₋₆amide, C₁₋₆ketone, C₃₋₆epoxide and C₁₋₆peroxide, or a combination of two or more thereof. Sometimes, the carboxylic acid is a C₁₋₄carboxylic acid such as acetic acid or acrylic acid. Sometimes, the ester is a C₁₋₄ester such as methyl acetate or vinyl acetate. Sometimes, the aldehyde is a C₂₋₄aldehyde such as propenal. Sometimes, the low-pressure plasma comprises ions formed from any one selected from the group consisting of a C₁₋₄carboxylic acid, C₁₋₄ester and C₂₋₄aldehyde, for example acetic acid, acrylic acid, methyl acetate, vinyl acetate and propenal, or a combination of two or more thereof. Sometimes, the low-pressure plasma comprises ions formed from any one selected from the group consisting of a C₁₋₆carboxylic acid, C₁₋₆ester, C₂₋₆aldehyde, C₁₋₆amide, C₁₋₆ketone and C₃₋₆epoxide, or a combination of two or more thereof.

In some embodiments, the low-pressure plasma comprises ions formed from any one selected from the group consisting of a carboxylic acid, alcohol, and amine, often a C₁₋₆carboxylic acid, a C₁₋₆alcohol and a C₃₋₆amine, or a combination of two or more thereof.

In some embodiments, the low-pressure plasma comprises ions formed from a carboxylic acid, often a C₁₋₆carboxylic acid, more often a C₁₋₄carboxylic acid, and typically acetic acid.

The first plurality of particles may be contacted with cement before the treating, i.e. the treating may be carried out on a composition comprising cement and the first plurality of particles. The first plurality of particles may be contacted with the cement by combining and mixing the two. Typically, however, the aggregates of the disclosure do not comprise cement. Rather, the aggregate may be contacted with cement to produce concrete.

In some embodiments, the treated particles are contacted with water. Without being bound by theory, it is thought that the pendant hydrophilic groups of the treated particles are able to rotate so that they are positioned within the surface rather than protruding from the surface and into the surrounding environment of the particle. A more hydrophilic environment, such as a more humid environment, may stabilise the pendant hydrophilic groups when they protrude from the particle surface (see M. R. Sanchis et al, Polymer Testing, 2008, 27, 75-83). Accordingly, contacting the treated particles with water may stabilise the pendant hydrophilic groups. Alternatively, or in addition, contacting treated particles with water may prevent the surfaces of such particles from being coated with dust and other materials in the air, which could alter the surface properties of the particles in a detrimental way.

The treated particles may be stored in containers, such as sealed bags, comprising water. In the containers, the treated particles may be wetted with water.

It is to be understood that other hydrophilic solvents including alcohols (such as C₁₋₆alcohols), acetone, ethyl acetate and acetonitrile, may be used instead of or in addition to water to stabilise the treated particles.

As described above, the aggregate in some embodiments comprises treated particles of different sizes. It is reported by J. Thorneycroft et al. (supra) that aggregate comprising plastic particles with a size distribution matched to that of the natural aggregate to be replaced produces concrete of better compressive and tensile strength. Accordingly, the particles of the aggregate of the disclosure may have a size distribution matched to that of a natural aggregate, such as sharp sand, builders sand or plaster sand, the size distributions of which are shown in FIGS. 1 to 3 and compared in FIG. 4.

At least some of the particles of the aggregate may have sizes ranging from about μm to about 4 mm or about 4.1 mm to about 1 cm. Often, at least some of the particles of the aggregate have sizes that lie within the range of about 0.1 μm to about mm.

Additives in concrete are defined as a material other than water, natural aggregates, cementitious materials and fibre reinforcement, used as an ingredient of a cementitious mixture to modify its freshly mixed, setting, or hardened properties and that is added to the batch before or during its mixing (ACI Committee 212, 2010).

Often, when the aggregate is intended to be used as an additive in concrete , the particles of the aggregate have sizes ranging from about 0.1 μm to about 0.1 mm, about μm to about 75 μm, or about 0.1 μm to about 63 μm. In some embodiments, the modal size of the particles of the aggregate is about 60 μm to about 2 mm, about 60 μm to about 1 mm, about 120 μm to about 1 mm, about 120 μm to about 0.8 mm or about 120 μm to about 0.7 mm. Often, the modal size of the particles of the aggregate is about 120 μm to about 0.7 mm. Typically, the modal size of the particles of the aggregate is from about 0.3 mm to about 0.6 mm.

In some embodiments, the modal size of the particles of the aggregate is within ±60%, ±50%, ±40% or ±30% of the modal particle size of sharp sand, builders sand or plaster sand. Accordingly, in some embodiments, the modal size of the particles of the aggregate is within ±60%, ±50%, ±40% or ±30% of the modal particle size of FIG. 1, FIG. 2 or FIG. 3. Sometimes, the modal particle size is within ±60%, ±50%, ±40% or ±30% of the modal particle size of sharp sand (FIG. 1). Sometimes, the modal size of the particles of the aggregate is within ±30% of the modal particle size of sharp sand (FIG. 1), builders sand (FIG. 2) or plaster sand (FIG. 3). Typically, the modal size of the particles of the aggregate is within ±30% of the modal particle size of sharp sand (FIG. 1).

The particles of the first plurality of plastic particles may comprise any type of plastic. Often, the particles of the first plurality comprise a mixture of plastic, such as a mixture of waste plastic. Using specific waste plastics can be less advantageous in requiring collection of the specific waste material or sorting of the specific waste material from plastic waste. Consequently, using specific waste plastics is often costly and wastes unsorted, unsortable or unclassified bulk mixtures of plastic waste. Mixtures of recycled plastics are generally regarded as lacking utility and are often disposed of in landfills. The particles of the first plurality may comprise such mixtures of recycled plastic.

Typically, owing to impurities and left-over residue from previous use, waste plastics are subjected to a series of washing processes before use in the particles of the first plurality.

The particles of the first plurality often comprise a thermoplastic polymer and/or a thermosetting polymer. Owing to the irreversible formation of a polymer network on curing, thermosetting polymers are often more difficult than thermoplastic polymers to recycle. However, both thermosetting and thermoplastic polymers are suitable for use in the method of the disclosure: the particles of the first plurality may comprise either type of polymer.

The particles of the first plurality may comprise any one selected from the group consisting of polyethylene, polypropylene, polyurethane, polyisocyanurate, polyepoxide, polyester resin, polysiloxane, styrene butadiene, polyethylene terephthalate, polybutylene terephthalate, polyvinylchloride, polycarbonate, polystyrene, ethyl vinyl acetate, and acrylonitrile butadiene styrene, or a combination of two or more thereof. Often, the first plurality comprises any one selected from the group consisting of polyethylene, polypropylene, polyurethane, polyepoxide, polyester resin, and polysiloxane, or a combination of two or more thereof. Typically, the particles of the first plurality comprise any one selected from the group consisting of polyethylene, polypropylene and polyurethane, or a combination of two or more thereof.

In some embodiments, the particles of the first plurality comprise one type of polymer. The particles of the first plurality typically comprise any one selected from the group consisting of polyethylene, polypropylene, polystyrene and polyurethane.

The second aspect of the disclosure provides an aggregate obtainable by the method of the first aspect. The term “obtainable” herein includes within its ambit the term “obtained”, i.e. the aggregate of the second aspect of the disclosure may be obtained by the method of the first aspect of the disclosure. The aggregate is obtainable by treating a first plurality of plastic particles with low pressure plasma and/or an electron beam to provide treated particles, wherein the plasma comprises ions formed from any one selected from the group consisting of a carboxylic acid, alcohol, amine, ester, aldehyde, amide, ketone, epoxide, ammonia and peroxide, or a combination of two or more thereof. In particular embodiments, the plasma comprises ions formed from any one selected from the group consisting of a carboxylic acid, alcohol, amine, ester, aldehyde, amide, ketone, epoxide and peroxide, or a combination of two or more thereof.

In the third aspect, there is provided an aggregate comprising plastic particles of about 0.1 μm to about 1 cm, wherein at least some particles of the aggregate comprise surfaces comprising pendant groups selected from any one of or a combination of two or more of carboxyl, alkoxy, hydroxyl, amino, imido alkylidene, ester, aldehydo, acyl, amido, keto, epoxy, cyano and peroxide groups, wherein the at least some of the particles have been treated with a) an electron beam, or b) low-pressure plasma. Such hydrophilic groups at the surfaces of at least some of the plastic particles are able to act as pozzolans. Thus, when used as a component of concrete, the aggregate of the third aspect is able to increase the rate of concrete curing and disperse throughout the cement with improvement of the structure and strength of the concrete that forms.

In some embodiments, the pendant groups are selected from any one of or a combination of two or more of carboxyl, ester, aldehydo, amino, amido, keto and peroxide groups, preferably one of or a combination of two or more of carboxyl, alkoxy, hydroxyl, amino, imido alkylidene and ester groups, more preferably one of or a combination of two or more of carboxyl, amino, amido and ketone, yet more preferably one of or a combination of carboxyl and ester.

The aggregate of the third aspect is obtainable by the method of the first aspect of the disclosure: cross-linked surfaces may form on low-pressure plasma treatment and/or electron beam treatment; and pendant groups may form on treatment with low-pressure plasma ions formed from any one selected from the group consisting of carboxylic acid, alcohol, amine, ester, aldehyde, amide, ketone, epoxide, ammonia and peroxide, or a combination of two or more thereof.

In some embodiments, the surfaces of at least some of the particles of the aggregate comprise pendant groups selected from any one or a combination of two or more of carboxyl, alkoxy, hydroxyl, amino, imido alkylidene, ester, aldehydo, acyl, amido, keto, epoxy and peroxide groups.

Often, the pendant groups are derived from precursors that are liquid at a pressure of atmospheric pressure and a temperature of 20° C. Accordingly, the pendant groups are often any one of or a combination of two or more of carboxyl, alkoxy, hydroxyl, C_{≥3}amino (often C₃₋₆amino), C_{≥3}imido alkylidene (often C₃₋₆imido alkylidene), ester, C_{≥2}aldehydo, C_{≥2}acyl, amido, keto, C_{≥3}epoxy (often C₃₋₆alkyl epoxy such as 1,2-epoxy-propyl), and peroxy groups. Often, the pendant groups comprise no more than 6 carbon atoms. Thus, the pendant groups are often any one selected from the group consisting of a C₁₋₆carboxyl, C₁₋₆alkoxy, C₁₋₆hydroxyl, C₃₋₆amino, C₃₋₆imido alkylidene, C₁₋₆ester, C₂₋₆aldehydo, C₂₋₆acyl, C₁₋₆amido, C₁₋₆keto, C₃₋₆epoxy and C₁₋₆peroxy groups, or a combination of two or more thereof.

Sometimes, the carboxyl is a C₁₋₄carboxyl such as —CH₂C(O)OH or —CHCHC(O)OH. Sometimes, the ester is a C₁₋₄ester such as —CH₂C(O)OCH₃, —CH₂OC(O)CH₃, —CHCHOC(O)CH₃ or —CH₂C(O)OCHCH₂. Sometimes, the aldehydo is a C₂₋₄aldehyde such as —CHCHC(O)H. Sometimes, the low-pressure plasma comprises ions formed from any one selected from the group consisting of a C₁₋₄carboxyl, C₁₋₄ester and a C₂₋₄aldehyde, for example —CH₂C(O)OH, —CHCHC(O)OH, —CH₂C(O)OCH₃, —CH₂OC(O)CH₃, —CHCHOC(O)CH₃, —CH₂C(O)OCHCH₂ and —CHCHC(O)H, or a combination of two or more thereof.

In some embodiments, the pendant groups are selected from any one of or a combination of two or more of carboxyl, ester, aldehydo, acyl, amido, keto and epoxy groups, often C₁₋₆carboxyl, C₁₋₆ester, C₂₋₆aldehydo, C₂₋₆acyl, C₁₋₆amido, C₁₋₆keto and C₃₋₆epoxy groups.

Often, the pendant groups are selected from any one of or a combination of two or more of carboxyl and ester groups such as C₁₋₆carboxyl, and C₁₋₆ ester groups. Typically, the pendant groups are carboxyl groups, such as C₁₋₆ carboxyl groups. Often, the carboxyl groups are C₁-C₄ carboxyl groups, typically —CH₂COOH groups.

In one embodiment, at least some particles of the aggregate of the third aspect comprise cross-linked surfaces. The degree of cross-linking may be determined by analysis of the glass transition temperature (T_{g}). This is the temperature range at which a polymer transitions from a hard “glassy” state to a pliable or “rubbery” state and is often measured by differential scanning calorimetry (DSC). In DSC, the heat output from a polymer is measured as a function of temperature. As a polymer transitions from a glassy to a rubbery state, its specific heat capacity increases, leading to an increase in heat output. The temperature at which the heat output from the polymer increases is the T_{g}. T_{g} is defined by IUPAC to refer to the temperature at which the viscosity of the polymer is 10¹³ dPa s.

As the degree of cross-linking at the surface of the aggregate increases, T_{g} increases until a point, beyond which the aggregate exhibits no T_{g}. In some embodiments, the aggregate does not express a T_{g}.

Alternatively, the degree of cross linking may be determined by dissolution testing.

In one embodiment, about 0.1 to about 100%, preferably about 0.5% to about 80%, more preferably about 1% to about 50%, yet more preferably about 5% to about 35%, such as about 10% to 30%, for example about 15% to about 25% of the at least some particles that have been treated with an electron beam are cross linked as determined by dissolution testing. The method of the dissolution testing is described in Example 3.

Alternatively, the degree of cross-linking may be inferred by analysis of the gel content of one or more plastic particles of the aggregate. The gel content is the insoluble fraction of the aggregate. Cross-linking the polymer within the particles of the aggregate strengthens the structure of the polymer and reduces its solubility, thus a polymer with a greater degree of cross-linking is less soluble than a polymer with a smaller degree of cross-linking.

The gel content may be measured using the ASTM D2765 Test Method A (see J. W. Kim and H. S. Choi, J. Appl. Polym. Sci., 2002, 83(13), 2921-2929; where the use of ASTM Designation: D 2765-95 is described http://www.astm.org/cgi-bin/resolver.cgi?D 2765-95. This has since been superseded by the ASTM D2765-16 Standard Test Method (https://www.astm.org/Standards/D2765.htm).

In this method, a sample of aggregate of a known mass is placed in a pre-weighed stainless steel cage suitable for immersing the aggregate in solvent (e.g. a stainless steel cage of mesh 150). The cage and aggregate are immersed in decahydronaphthalene or xylene and vigorously boiled for 6 or 12 hours, respectively. If xylene is used, a stabiliser such as 2,6-ditert-butyl-4-methylphenol, may also be employed. After boiling, the cage and aggregate are dried to a constant weight, for example in a vacuum oven. The dry cage and aggregate are cooled to room temperature and weighed in order to compare the masses after extraction into decahydronaphthalene or xylene with the masses before extraction into decahydronaphthalene or xylene. The gel content is calculated as:

$$Gel content ( \% ) = \frac{mass of aggregate after extraction}{mass of aggregate before extraction} \times 100.$$

Often, the gel content of one or more plastic particles of the aggregate measured by ASTM D2765-16 Test Method A is about 0.1% to about 100%, about 0.2% to about 80%, about 0.5% to about 50%, about 0.8% to about 25% or about 1% to about 15%. Sometimes, the gel content is about 0.5% to about 50%, about 0.8% to about 25% or about 1% to about 15%.

The range in gel content of the one or more plastic particles of the aggregate is dependent on the method used to cross-link the surface of the particles. When the polymer within the particles of the aggregate is cross-linked via exposure to an electron beam, the gel content of the aggregate measured by ASTM D2765-16 Test Method A may range from about 0.1% to about 100%. In contrast, when low-pressure plasma is used to cross-link the polymer within the particles of the aggregate, the gel content of the aggregate measured by ASTM D2765-16 Test Method A may range from about 0.1% to about 70%. Typically, low-pressure plasma is used to cross-link the polymer within the particles of the aggregate, and the gel content ranges from about 0.1% to about 70%. In some embodiments, the particles of the aggregate are not perfectly spherical, i.e. they have aspect ratios smaller than or greater than 1 (1 being the aspect ratio of a sphere). In some embodiments, the particles of the aggregate are not perfectly spherical or perfectly spheroidal. In some embodiments, the particles of the aggregate are angular, often angular and close-to spherical in shape (having aspect ratios of about 1). In particular embodiments, the particles of the aggregate have sides and angles of different lengths and sizes.

As described above, treatment of plastic particles with low-pressure plasma or an electron beam may alter the topography of the surfaces of the particles through cross-linking polymer chains or causing the scission of polymer chains. As a result, the surface of the plastic aggregate may be rougher and more adhesive following such treatment.

It is to be understood that the limitations disclosed herein in relation to the first plurality of particles (such as the size, shape and composition of the particles) also apply to the particles of the aggregate of the third aspect. For example, the particles of the aggregate of the third aspect may be of different sizes; may have a modal size of about 120 μm to about 0.7 mm; may have a modal size that is within ±60%, ±50%, ±40% or ±30% of the modal particle size of sharp sand, builders sand or plaster sand; and/or comprise any one selected from the group consisting of polyethylene, polypropylene and polyurethane, or a combination of two or more thereof.

As described above, the aggregates of the disclosure may be useful as concrete additives or as natural aggregate replacements in concrete. In the fourth aspect there is provided concrete comprising the aggregate of the second or third aspect. The inventors have found that concrete comprising the aggregate of the disclosure has increased compressional strength and cures more quickly with respect to concrete comprising untreated plastic particles. Furthermore, concrete comprising the aggregate of the disclosure surprisingly requires significantly less water to prepare with respect to concrete comprising untreated plastic particles. Since water content is reported to be inversely proportional to concrete strength, the use of less water in the concrete composition is desirable (see J. Afsar Engineering Intro, “Water to Cement Ratio”, 2012; and A. Neville, Properties Of Concrete, 5^{th} Edition, Pearson Education Limited, Harlow, 2011).

The concrete may comprise a natural aggregate (such as sand):aggregate ratio range of about 49:1 to about 0:1, about 8.1:1 to about 0:1, about 49:1 to about 0.1:1, about 8.1:1 to about 0.2:1, about 19:1 to about 0.25:1, about 9:1 to about 0.66:1, about to about 0.82:1, or about 2.7:1 to about 1:1.

The concrete may comprise about 0.5 wt % to about 70 wt % of the aggregate, such as 0.5 wt % to 20 wt %. Concrete, such as for use in thermal blocks, may comprise from about 1 wt % to about 70 wt % of the aggregate, often about 15 wt % to about 70 wt % of the aggregate.

Alternatively, when the aggregate is used as an additive, the concrete may comprise about 0.0005 to about 1 wt %, about 0.00125 to about 0.75 wt %, about 0.00125 to about 0.5 wt % of the aggregate. Alternatively, when making the concrete, the additive quantity is determined as a wt % of the cement content wherein the aggregate is about to about 2 wt %, about 0.025 to about 1.5 wt %, or about 0.025 to about 1 wt % of the cement content. The skilled person is aware that concrete typically comprises cement.

The concrete may comprise a specific volume ratio of cement to aggregate ranging from about 0.1:1 to about 3:1, about 0.3:1 to about 2.5:1 or about 0.4:1 to about 2.2:1.

The concrete may comprise one or more additives such as any one selected from the group consisting of glass, flyash, graphene oxide, calcium carbonate, one or more ground pozzolans, air entraining agents, superplasticisers, curing accelerants/retardants and rheology modifiers, or a combination of two or more thereof. The additive may be present in the concrete in an amount of about 0.01 to about 20 wt %, about 0.01 to about wt %, about 0.1 to about 10 wt %, or about 0.5 to about 5 wt %.

The additives may provide an emulsifying effect, which may create a more uniform concrete structure.

The concrete of the fourth aspect may be used in construction, for example in the construction of buildings, bridges, roads, dams, blocks and other precast applications. It may be used for the foundations of a structure or may be used within the structure itself.

In a fifth aspect, there is provided a method of making concrete comprising contacting the aggregate of the second or third aspect with cement. Usually, contacting entails combining and often mixing the aggregate and cement. Often, a cement mixer is used. Typically, the method further comprises contacting the cement and aggregate with water.

The cement may be any binder used to adhere material together, and to set and harden the resulting composition. Often, the cement comprises any one or a mixture of calcium oxide, calcium hydroxide and calcium silicate. Typically, the cement is a hydraulic cement such as Portland cement, which reacts with water via Pozzolanic reactions to cure and set.

Portland cement is usually made by heating limestone and clay minerals to form a clinker, which is ground and contacted with gypsum. Portland cement typically consists of at least two-thirds by mass of calcium silicates, with the remainder consisting of aluminum- and iron-containing compounds. The ratio of CaO to SiO₂ within Portland cement is at least 2:1.

Often, the method of the fifth aspect further comprises contacting the cement and aggregate with water, wherein the water to cement weight ratio is about 0.2:1 to about about 0.3:1 to about 0.55:1 or about 0.4:1 to about 0.5:1. Sometimes, the water to cement ratio is about 0.48:1.

Often, the method of the fifth aspect further comprises contacting the cement and aggregate with an additive. It is to be understood that the limitations disclosed herein in relation to the additives of the fourth aspect (such as the type and wt %) also apply to the additives of the fifth aspect. For example, the additive may be graphene oxide, used in an amount of about 0.001 to about 1 wt %.

In a sixth aspect, there is provided use of the aggregate of the second or third aspect as a replacement for natural aggregate (e.g., sand) in concrete.

About 5 to about 100 vol %, about 20 to about 100 vol %, about 40 to about 100 vol %, about 60 to about 100 vol %, or about 80 to about 100 vol % of natural aggregate may be replaced by the aggregate. Alternatively, about 0.01 to about 2 vol %, about 2 to about 20 vol %, about 20 to about 60 vol %, or about 60 to about 100 vol % of natural aggregate may be replaced by the aggregate.

Suitably the natural aggregate that is replaced by the aggregate is sand, such as sharp sand, plaster sand or builders sand. Preferably, the natural aggregate that is replaced by the aggregate is sharp sand.

### EXAMPLES

The following non-limiting examples serve to illustrate the disclosure further.

### Materials

Tarmac blue circle sand and blue circle mastercrete cement was purchased from Wickes (4 varieties of sand: sharp sand, builders sand, plaster sand and ballast). Ballast consists of sharp sand and stones of at least about 10 mm in size. Polyethylene flakes (larger than 4 mm flakes) and polyethylene fines (a waste stream of small polyethylene particles between 63 μm and 4000 μm) were used.

The chemicals used for the plasma modification of plastic substrates (40 mm ×mm) and plastic particles (250 μ-10 mm) were acrylic acid (AA) (98%, extra pure, stabilized, Acros Organics), Cyclopentanone (CP) (99+%, pure, Acros Organics), ethylenediamine (EDA) (ReagentPlus®, ≥99%, Sigma Aldrich) and dimethylformamide (DMF) (99+%, extra pure, Acros Organics) and were all used as received. Sand (sharp sand <4 mm) and gravel (4-10 mm limestone) were used as the natural aggregates for the concrete mix designs.

Acrylic acid (carboxylic acid —COOH) modification was chosen to represent similar functional group chemicals such as alcohols (—OH) and esters (—COOR). Ethylene diamine (amine) modification was chosen to represent similar nitrogen containing chemicals such as ammonia. Cyclopentanone (ketone) modification was chosen to represent similar chemicals with carbonyl groups such as aldehydes. Dimethylformamide (amide) modification was chosen to represent similar nitrogen containing amides.

Plastic substrates and particles used were polyethylene (PE), polyurethane (PU), polyethylene terephthalate (PET), polystyrene (PS), polystyrene butadiene (SB), epoxy resin (PEX), polypropoylene (PP) and polyvinyl chloride (PVC). PEX and PU particles were produced from casting commercially available liquid resin components. PE was chosen to represent thermoplastics with low degrees of polymer backbone branching such as polypropylene, polyvinyl chloride and ethyl vinyl acetate. PET and PS were chosen to represent thermoplastics with ring systems such as polycarbonate, polybutylene terephthalate and acrylonitrile butadiene styrene. SB was chosen to represent thermoplastic and thermosetting rubbers of similar materials such as acrylonitrile butadiene styrene and high vinyl content ethyl vinyl acetate. PEX was chosen to represent thermosetting plastics with a commonly high degree of cross-linking such as polysiloxane, polyester resins and PU's. PU was chosen to represent thermosetting plastics and thermoplastics that contain carbon-nitrogen bonds, such as polyisocyanurate (PIR).

### Methods

### Size Distribution

The size distribution of the dry sand was determined via sieve stack separation using mesh sizes of 5 (4000 μm), 10 (2000 μm), 35 (500 μm), 120 (125 μm), 300 (63 μm); the mass of the sand of each size was determined using a digital balance. The pan is defined as any particles less than 63 μm.

### Water Content in Sand Varieties

The water content was determined by comparing the mass (using a digital balance) of sand before and after drying the sand at 90° C. for 24 hours.

### Plastic Particle Size Reduction

Plastic particles were reduced in size using a standard kitchen blender (2000 W), a shredder (SHR3D IT) from 3Devo and/or a granulator (Crushmaster).

### Plasma Modification

Plastic substrates and particles were plasma treated using a Haydale HT60 Plasma Reactor with a rotating barrel. All plasma treatment mentioned herein is low pressure plasma treatment. Plasma parameters for the plastic substrates were:
Power: 20 W
Time: 2 minutes
Pressure: 0.1 mbar
Gas flow rates: 50 sccm
   Plasma parameters for the plastic particles were:
Power: 20-200 W
Time: 20-60 minutes
Rotation speed: 5-40 rpm
Pressure: 0.1-0.7 mbar
Gas flow rates: 50-100 sccm

### Electron Beam Treatment

Plastic substrates were electron beam treated using a EBLab system. Electron beam treatment was conducted on 40 mm×40 mm plastic substrates. The substrates were irradiated with powers ranging from 80 keV to 200 keV and dosage levels ranging from 30 kGy to 900 kGy.

### Contact Angle Measurements

The contact angle of water droplets on treated plastic surfaces were measured by an Ossila contact angle goniometer. For each plastic, 3 substrates were analysed.

On each substrate, 3 droplets of water (10 μL each) were deposited and a picture taken. The pictures were analysed by the Ossila contact angle software. After calculating an average contact angle of the 3 droplets for each substrate, the final contact angle was calculated as an average of the values measured on the three individual substrates.

### X-ray Photoelectron Spectroscopy

X-ray photoelectron spectroscopy (XPS) data was collected from a Thermo K-Alpha⁺ spectrometer with a spot size of 400 μm at a pass energy of 40 eV using micro-focused monochromatic Al radiation. The data was analysed using CasaXPS software. 10 Peak shapes were fitted using Voigt profiles and peak assignments were made by cross referencing binding energies to published values.

### Example 1

### Concrete Production

Cylindrical concrete sample classes were labelled P1, P2, P3, P4, P5 and P6 and cube concrete samples were labelled P7 and P8. Concrete cylinders (38 mm×97 mm) were produced for porosity and compressional strength measurements. Concrete cylinders for compressional strength tests used sand from the supplied bag without drying to remove the bound water. Concrete cubes (50 mm×50 mm) were produced for 7 day compressional strength measurements. The concrete cubes used for compressional strength tests used sand from the supplied bag without drying to remove the bound water.

### Sample P1

A 1:5 cement:sand ratio was used. Blue circle mastercrete cement was mixed with sharp sand in a bucket, water was then added, and the mixture was stirred by hand using a metal spatula. The slurry was then mixed using an automatic concrete mixer for 300 seconds at 120 rpm. The slurry was then added to cylindrical plastic moulds capped at the bottom with a plastic disc. One third of each cylinder was filled with the slurry and tamped 10-20 times using a steel hexagonal rod (width 25 mm). This was repeated twice more to produce cylinders full of slurry. The cylinders were levelled and left to cure for 3 days under a plastic sheet in air. After 3 days, the moulds were removed using a saw. 15 cylinders were produced with this mix. The mix temperature was 15.6° C. directly after stirring in the water. See Table 1 for more details.

### Samples P2, P3 and P4

The same procedure for the preparation of sample P1 was used to prepare samples P2, P3 and P4, except that about 20% of the sand was replaced with polyethylene, using a volume ratio of 0.5 (1.2 kg of sand replaced with 0.6 g of plastic). The mix temperature of P2 and P3 was 15.6° C. and was 16.2° C. for P4. Oxygen low-pressure plasma-modified plastic was used to prepare sample P3 and carboxylic acid low-pressure plasma-modified plastic was used to prepare sample P4. See Table 1 for more details.

### Samples P5 and P6

The same procedure for the preparation of sample P1 was used to prepare samples P5 and P6, except that 100% and about 90% of the sand was replaced (using a volume ratio of 0.5) with polyethylene to prepare P5 and P6, respectively. carboxylic acid-modified plastic was used in both samples. The mix temperature was not measured. See Table 1 for more details.

### Samples P7 and P8

Blue circle mastercrete cement was mixed with sharp sand and plastic in a bucket. Water was then added, and the mixture was stirred by hand using a metal spatula. The slurry was then added to the cube moulds. One third of each cube was filled with the slurry and tamped 25 times using a square steelrod (10 mm). This was repeated twice more to produce cubes full of slurry. The cubes were levelled and left to cure for 24 hours under a wetted plastic sheet in air. After 24 hours, the moulds were unbolted and the hardened concrete was placed in a curing tank at 20° C. 9 cubes were produced per mix. See Table 1 for more details.

TABLE 1
Compositions of samples P1 to P8

| | | Plastic | Sand | Cement | Water | Plastic | Free water: |
|---|---|---|---|---|---|---|---|
| Sample | Plastic | Modification | (Kg) | (Kg) | (Kg) | (Kg) | cement |
| P1 | N/A | N/A | 3.9 | 0.8 | 0.3 | 0 | 0.375 |
| P2 | Polyethylene | None | 5 | 1.28 | 0.72 | 0.6 | 0.539 |
| P3 | Polyethylene | Oxygen | 4.68 | 1.2 | 0.67 | 0.585 | 0.475 |
| P4 | Polyethylene | Carboxylic acid | 4.68 | 1.2 | 0.57 | 0.585 | 0.475 |
| P5 | Polyethylene | Carboxylic acid | 0 | 0.19 | 0.25 | 0.465 | 1.32 |
| P6 | Polyethylene | Carboxylic acid | 0.093 | 0.19 | 0.25+ | 0.419 | — |
| P7 | Polyethylene | Carboxylic acid | 1.975 | 0.826 | 0.496 | 0.244 | 0.6 |
| P8 | Polyethylene | None | 1.628 | 0.69 | 0.414 | 0.204 | 0.6 |

### Porosity Measurements

Initial porosity measurements were taken with an ultrasonic probe, values obtained are from 1 sample of each sample class.

### Concrete Slurry Temperature

The concrete slurry temperature was measured after the water was mixed into the dry aggregates using an infrared thermometer.

### Compressional Strength Measurements

Compressional strength measurements were carried out on an Instron 34TM-30 machine. Compressional strength was measured on between 5-7 cylinders for each sample class at 3, 7 and 28 days. 3 days subsequent to their removal from the moulds, the samples were placed in a water bath. The 28-day samples were dried in an oven at 90° C. for 40 minutes before testing. The compressional strength was measured on 4 cubes for each sample at 7 days.

### Results and Discussion

### Size Distribution of Sand Varieties

Size distribution analysis was carried out for sharp sand, builders sand and plaster sand. Builders sand and plaster sand contained a large portion of small particles, whereas sharp sand contained some larger particles (see Table 2 and FIGS. 1 to 4).

TABLE 2
Percentage size distribution found for sharp sand,
builders sand and plastersand

| | | | | | | Pan |
|---|---|---|---|---|---|---|
| Sample | 4000 μm | 2000 μm | 500 μm | 125 μm | 63 μm | (<63 μm) |
| Sharp sand | 3.01 | 20.0 | 39.48 | 31.23 | 5.24 | 1.04 |
| Builders sand | 0 | 1.01 | 26.53 | 59.50 | 11.73 | 1.23 |
| Plaster sand | 0 | 0.92 | 22.11 | 64.10 | 11.73 | 1.14 |

Size Distribution Matching of Sharp Sand with Polyethylene

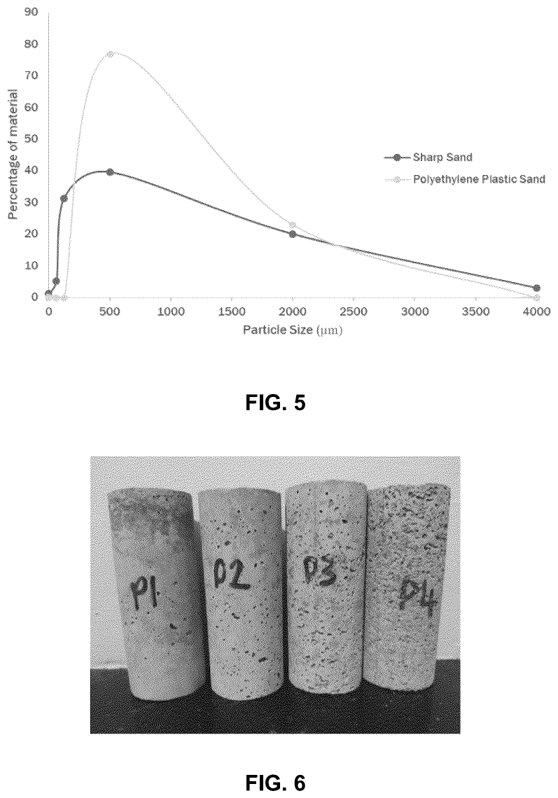

Size distribution analysis was carried out for polyethylene fines and shredded polyethylene flakes (Table 3). Polyethylene fines and shredded flakes were grouped into two categories: less than or equal to 500 μm and above 500 μm. The particles that were less than or equal to 500 μm accounted for 77% of the total mass (obtained from 500 μm sieve-polyethylene fines) and the particles above 500 μm accounted for 23% of the total mass (obtained from 2 mm sieve-shredded polyethylene flakes). This resulted in the polyester distribution shown in FIG. 5 where it is compared with the size distribution of sharp sand).

TABLE 3
Percentage size distribution found for sharp sand,
shredded polyethylene and polyethylene fines

| | | | | | | Pan |
|---|---|---|---|---|---|---|
| Sample | 4000 μm | 2000 μm | 500 μm | 125 μm | 63 μm | (<63 μm) |
| Sharp sand | 3.01 | 20.0 | 39.48 | 31.23 | 5.24 | 1.04 |
| Polyethylene | 8.66 | 82.07 | 9.19 | 0.08 | 0 | 0 |
| (shredded) | | | | | | |
| Polyethylene | 5.12 | 21.84 | 69.37 | 3.49 | 0.18 | 0 |
| (fines) | | | | | | |

### Surface Topology Investigation Using Scanning Electron Microscopy

Scanning electron microscopy (SEM) was carried out to obtain images of sharp sand, blended polyethylene flakes and polyethylene fines. The SEM images showed sharp sand to have an irregular shape with an extremely rough surface. The irregular shape was matched by the polyethylene fines and shredded flakes.

### Water Content in Sand Varieties

Water, defined as ‘bound water,’ should be taken into account when calculating the water required for the concrete mix. The water content was measured in sharp sand, builders sand, plaster sand and ballast (see Table 4). Builders sand had the highest water percentage of the group at 11.3%, followed by plaster sand at 9.8%, and then sharp sand at 9.6% and finally, ballast had the lowest water content at 6.8%. These results seem to correlate with sand particle size: the smaller the sand particles the more bound water.

TABLE 4
Percentage water content found for sharp sand,
builders sand, plaster sand and ballast

| | Mass | Mass of wet | Mass of dry | |
|---|---|---|---|---|
| | of | sand and | sand and | Water |
| Sand | jar (g) | jar (g) | jar (g) | (%) |
| Sharp sand | 234.10 | 370.00 | 356.91 | 9.6 |
| Builders sand | 242.00 | 335.70 | 325.07 | 11.3 |
| Plaster sand | 241.91 | 347.54 | 337.20 | 9.8 |
| Ballast | 242.20 | 404.00 | 393.00 | 6.8 |

### Concrete Production

All concrete mixes were made to achieve similar workabilities. Therefore, the volume of water used was changed to achieve the same slurry consistency. This was measured by slump tests.

During the production of sample P1, the bound water (volume of water close/bound to sand particles) of the supplied sand was taken into account. However, when mixed it was clear that the mix was dry. This indicated the difference between free water (water added to the mix) and bound water. The bound water is expected to contribute to the overall water content, however, it doesn't appear to contribute to the workability as significantly as free water.

Sample P2 required more water to achieve the same slurry consistency as sample P1. This was most likely due to plastic requiring more water to wet the surface due to its hydrophobic nature. Exchanging wet sand for dry plastic also decreases the amount of bound water present. In addition, the particle surface area of dry plastic is expected to be lower, changing the amount of water required. Addition of water is reported to directly correlate with weaker concrete (see J. Afsar, 2012 and A. Neville, 2011, supra).

During the preparation of sample P3, the water content necessary to achieve the same slurry consistency as sample P2 was significantly lower. This indicates that oxygen plasma treatment increases the surface energy of the plastic resulting in less water being required to wet the plastic. Sample P4 required the same water content as sample P3, again indicating that the surface is more hydrophilic than sample P2.

The concrete samples (P1 to P4) were removed from the cylindrical moulds after 3 days. It was immediately observed that samples P3 and P4 contained pits on the surface of the concrete (see FIG. 6), which may be attributed to the lower amount of water used in preparation of these samples, or more cement/water at the surface of the plastic. The observation of pits would suggest that the porosity of the concrete has increased.

### Density and Porosity of the Concrete Samples

One of the potential benefits in preparing concrete with plastic aggregate partially replacing sand aggregate is producing lightweight concrete. Lightweight concrete is defined as having a density of less than 2000 kg/m³ (see http://www.daygroup.co.uk/downloads/datasheets/concrete.pdf). Concrete samples P2 to P8 all exhibit densities of less than 2000 kg/m³ and are therefore classed as lightweight concrete samples (see Table 5).

TABLE 5
Average density measured for samples P1 to P8.

| Sample | Average Density (kg/m³) |
|---|---|
| P1 | 2243.30 |
| P2 | 1877.80 |
| P3 | 1847.17 |
| P4 | 1865.97 |
| P7 | 1731.49 |
| P8 | 1719.72 |

The compressional strength of concrete is related to the porosity of the concrete. Generally, the higher the porosity, the lower the compressional strength as there is less material present and more air entrained. The porosity is measured using the speed of sound through the material. It is expected that when plastic is present in concrete, the speed of sound will decrease as the speed of sound in polyethylene is ˜1900 m/s compared to over 5000 m/s for quartz (sand). The speed of sound in sample P1 (no plastic present) is 3000 m/s. As expected, the speed of sound decreases in samples P2 to P4 (comprising plastic), where it is 2400 m/s, 2350 m/s and 2350 m/s, respectively (see Table 6).

TABLE 6
Speed of sound measured through samples P1 to P4.

| Sample | Speed of sound (m/s) |
|---|---|
| P1 | ~3000 |
| P2 | ~2400 |
| P3 | 2300-2400 |
| P4 | 2300-2400 |

### Compressional Strength Measurements

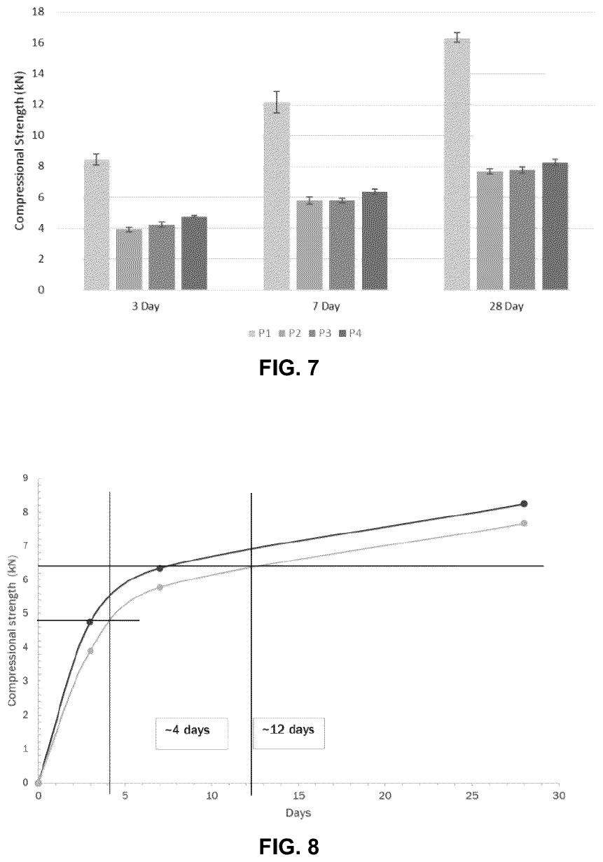

The compressional strength of samples P1 to P4 was measured after 3, 7 and 28 days. The compressional strength increases as a function of time for all samples. Sample P1 (no plastic) has the highest compressional strength compared to P2 to P4 over all days (about 4 kN, 6 kN and 8 kN stronger than samples P2 to P4 at day 3, 7 and 28, respectively). The compressional strengths of P2 to P4 are similar (less than ±1 kN difference when comparing between samples for the same curing time). Sample P4 is consistently stronger than P2 and P3 over all curing times and P2 is consistently the weakest sample over all curing times (see FIG. 7).

Considering the increased porosity of samples P3 and P4, which is well known to weaken concrete, it is surprising that the compressional strength is higher than that of P2. These results suggests that plasma treatment of the plastic used in samples P3 and P4 increases the compressional strength of the resultant concrete. It is expected that reduced water content and increased bonding between the plasma-treated plastic and cement matrix is the cause for the increased strength.

Sample P4 exhibits the highest compressional strengths in comparison with samples P2 and P3. It is predicted that low-pressure carboxylic acid plasma treatment of the plastic used results in increased bonding with the cement matrix, and causes nucleation of cement crystallization, which results in an increased curing rate. The difference in compressional strength between the samples decreases over time. At 28 days of curing time, the concrete is expected to have 99% of its final strength. Therefore, the biggest differences in compressional strength are expected to be observed at lower curing times. When comparing the time taken for sample P2 to reach the compressional strength of sample P4 at 3 days and 7 days, it can be seen from FIG. 8 that sample P4 cured 25% faster after 3 days and 42% faster after 7 days.

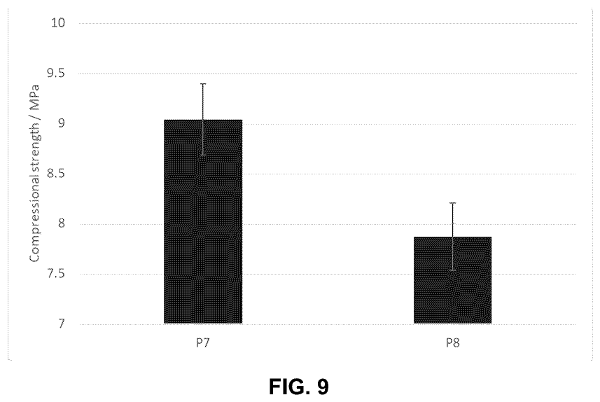

The compressional strengths exhibited by samples P7 and P8 after 7 days of curing are compared in FIG. 9. The compressional strength of concrete prepared using low-pressure carboxylic acid plasma treated polyethylene is 15% greater than that of concrete prepared using unmodified polyethylene.

### Conclusion

Polyethylene fines and shredded polyethylene flakes were combined to size-match the polyethylene aggregate with sharp sand.

Modification of the polyethylene particles with low-pressure oxygen and carboxylic acid plasma shows a noticeable decrease in the need for extra water required in the concrete mix to wet the surface of the aggregate. The use of less water is desirable as water content is inversely proportional to concrete strength (see J. Afsar, 2012, supra; and A. Neville, 2011, supra). Moreover, it is more environmentally friendly to use less water.

A comparison of the compressional strengths of concrete samples P2 to P4 suggests that modification of the polyethylene particles using low-pressure carboxylic acid plasma improves the strength of the resultant concrete the most (by 20% compared to unmodified plastic after 3 days). This suggests that modification of the plastic particles using low-pressure carboxylic acid plasma increase the speed of curing of the resultant concrete. Without being bound by theory, the inventors hypothesise that the carboxylic acid-derived groups that are bound to the surface of the plastic particles react with cement within concrete to form strong bonds with the concrete matrix, resulting in a higher compressional strength. An increased curing speed is desirable in the concrete industry.

Modification of the polyethylene particles using low-pressure oxygen plasma also improved the strength of the resultant concrete by 8% after 3 days (relative to the concrete sample comprising unmodified polyethylene particles.

Concrete cubes P7 and P8 exhibited a similar increase in compressional strength when compared to the cylinders tested after 7 days, providing further evidence that the modification using carboxylic acid groups produces stronger concrete. 28 day compressional data could not be obtained for these samples.

### Example 2

### Plastic Particle Production

Each plastic was size separated using sieves with mesh sizes n° 230 (0.063mm), 120 (0.125mm), 60 (0.25 mm), 35 (0.50 mm), 10 (2 mm) and 5 (4 mm), resulting in three different fractions of plastic particles with sizes between 2 and 4 mm, 0.50 mm and 2 mm, 0.25 mm and 0.50 mm. If required, bulk plastic was first size reduced through granulation prior to sieving.

### Concrete Production

Concrete mixes were prepared in a typical concrete mixer. Sand, large aggregate and cement were added to the mixer first and mixed for 3 minutes. In a separate container, the plastic particles were contacted with water. The plastic mix was then added to the concrete mixer. The resultant concrete was mixed for 10 minutes before being placed in 100 mm cube moulds.

### Mix Designs

In the situation whereby the plastic particles were incorporated into concrete as a natural aggregate substitute, the concrete mix design was as follows:
Cement:Sand:Gravel ratio of 1:4:0 (vol. %)
Water:Cement ratio of 0.27 (by mass)
Total content of plastic of 10.33 vol %

In the situation whereby the plastic particles were incorporated into concrete as an additive, the mix design as follows:
Cement:Sand:Gravel ratio of 1:1.1:2.8 (vol. %)
Water:Cement ratio of 0.30 (by mass)
Plastic particle content of 0.1-0.5 wt % (with respect to cement)
Total content of plastic of 0.0004-0.002 vol. %

### Moulding

Three cubes 100×100 mm were cast per mix, using steel moulds. The moulds were placed on a vibrating table, filled by a third with the concrete mix and vibrated for 30 seconds. This was repeated twice more until the moulds were completely filled and compacted. The concrete was left to cure for 24 hours under wetted sheeting (to avoid water evaporation) before being demoulded and crushed at a rate of 0.5 kN/s for the natural aggregate replacement and 5 kN/s for the additive inclusion, to measure the compressional strength.

### Results

### Plastic Static Water Contact Angle

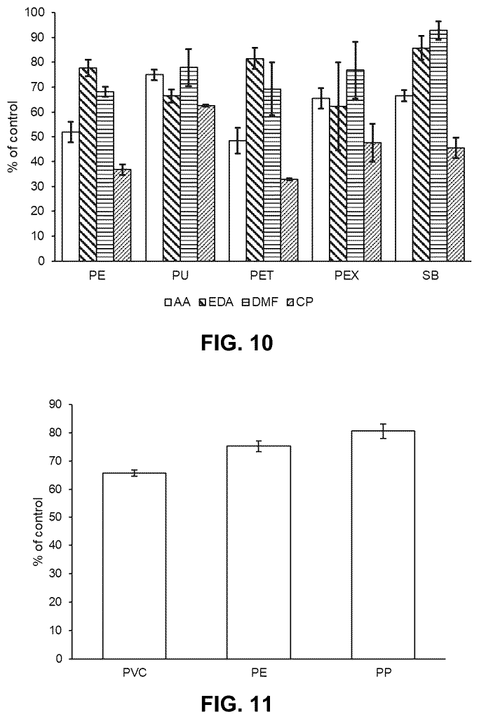

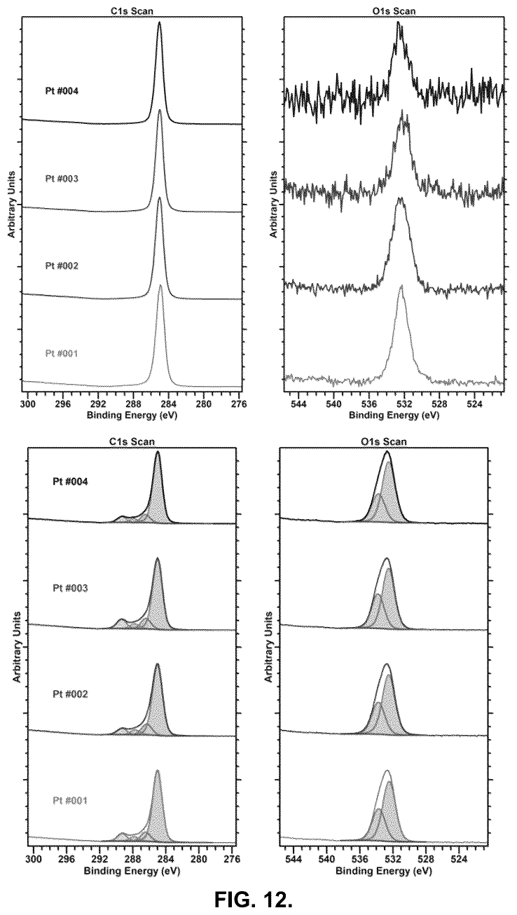

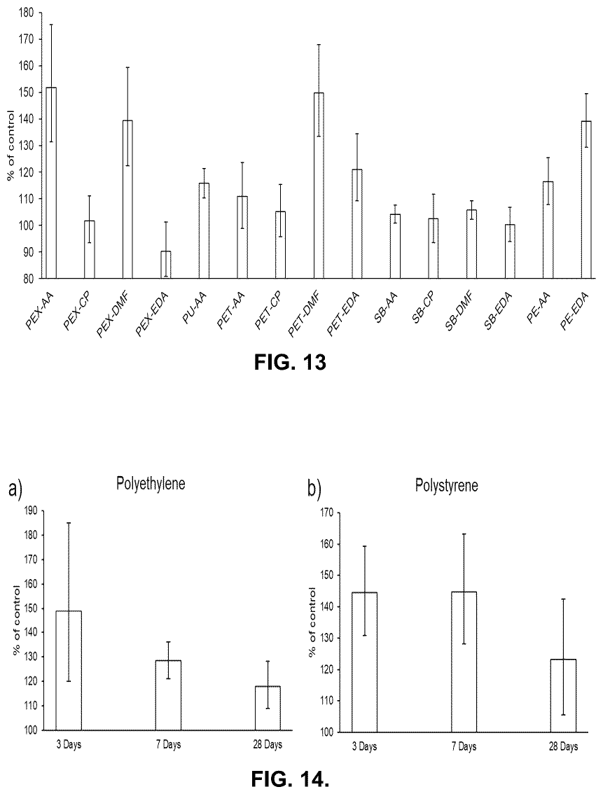

The static water contact angle was measured on both plasma treated and electron beam treated plastic substrates (FIG. 10 and FIG. 11, respectively). The larger the contact angle with water the more hydrophobic the surface is. The data shows that the contact angle decreases post plasma and electron beam treatment as the surface is altered with the attachment of chemical groups thereby becoming more hydrophilic. For example, when PE is plasma treated with EDA the contact angle is 78% of the control (plastic with no plasma treatment), meaning the contact angle has decreased by 22% (the surface is more hydrophilic) post treatment

### Plastic Particles Size

### Plastic Particles as a Natural Aggregate Replacement

The plastic particles (PE, PU, PET, PEX and SB) intended to be plasma treated and to replace natural aggregates were formulated by volume ratios (Table 7).

TABLE 7
Formulated size distributions and modal size for the plastic particles used
as a natural aggregate replacement.

| | Volume Ratios | | | |
|---|---|---|---|---|
| | 0.25-0.50 | 0.50-2.00 | 2.00-4.00 | Modal Size/ |
| Plastic | mm | mm | mm | mm |
| PE | 35 | 55 | 10 | 0.96 |
| PU | 0 | 25 | 75 | 2.8 |
| PET | 0 | 50 | 50 | 2.0 |
| PEX | 0 | 15 | 85 | 2.9 |
| SB | 0 | 75 | 25 | 1.4 |

### Plastic Particles as a Natural Aggregate Replacement (High Power)

The plastic particles (PE and PS) intended to be plasma treated (high power, 200W) and to replace natural aggregates were formulated by volume ratios (Table 8).

TABLE 8
Formulated size distributions and modal size for the plastic particles used
as a natural aggregate replacement.

| | Volume Ratios | | | |
|---|---|---|---|---|
| | 0.25-0.50 | 0.50-2.00 | 2.00-4.00 | Modal Size/ |
| Plastic | mm | mm | mm | mm |
| PE | 0 | 77 | 23 | 1.38 |
| PS | 0 | 77 | 23 | 1.38 |

### Plastic Particles as an Additive

Here, the plastic particles (PE) are intended to be used as an additive in concrete (0.0004-0.002%, vol. %). PE plastic particles were formulated by volume ratios resulting in the size distribution displayed in Table 9.

TABLE 9
Size distribution and modal size of the PE plastic particles used as
an additive.

| | Volume Ratios | | | |
|---|---|---|---|---|
| | 0.25-0.50 | 0.50-2.00 | 2.00-4.00 | Modal Size/ |
| Plastic | mm | mm | mm | mm |
| PE | 100 | 0 | 0 | 0.38 |

### X-ray Photoelectron Spectroscopy Analysis

X-ray photoelectron spectroscopy (XPS) analysis was performed on PE plastic particles to show that the chemical groups on the PE surface correspond with the chemical groups utilised in the plasma treatment the plastic was subjected to (in this case acrylic acid, AA —RCOOH). The PE volume ratio size distribution can be seen in Table 10. The treated PE plastic particles were subject to an initial plasma treatment using oxygen gas and a main treatment with AA, the parameters outlined below (Table 11).

TABLE 10
The volume ratio size distributions of PE particles used in the
plasma treatment for subsequent XPS analysis.

| | Volume Ratios | | |
|---|---|---|---|
| Plastic | 0.25-0.50 mm | 0.50-2.00 mm | 2.00-4.00 mm |
| PE | 0 | 0 | 100 |

TABLE 11
Plasma treatment parameters (initial and main treatment) for PE particles.

| | Plasma Parameters | | | |
|---|---|---|---|---|
| Plastic | Time | Pressure | Power | Gas Flow Rate |
| PE (Initial) | 5 mins | 0.1 mbar | 140 W | 100 sccm |
| PE (Main, AA) | 20 mins | 0.1 mbar | 20 W | 50 sccm |

Analysis of the XPS data shows that the oxygen content of the plasma treated plastic particles has increased when compared to the untreated plastic particles (1.5% O compared to 18.4% O) (Table 12). This is in line with what was expected if the plasma treatment with AA was successful, as there would be an increase in oxygen containing groups on the plastic surface such as —COOH (6.3%), —C═O (3.8%) and —OH (8.1%) (Table 13). This XPS data verifies that the PE surface contains AA moieties and that the use of acrylic acid plasma treatment is successful in obtaining carboxylic acid functional groups. The spectra used in the determination of the data in Table 12 and Table 13 can be seen in Error! Reference source not found, 12.

TABLE 12
XPS Analysis: Atomic % of oxygen, carbon and nitrogen on the surface
of the untreated and treated PE particles.

| Sample | Atomic % O | Atomic % C | Atomic % N |
|---|---|---|---|
| Untreated PE | 1.5 + 1.1 | 98.4 + 1.5 | N/A |
| Particles | | | |
| Treated PE | 18.4 + 1.5 | 80.56 + 1.4 | 0.64 + 0.2 |
| Particles | | | |

TABLE 13
XPS Analysis: Atomic % of oxygen containing groups on the surface
of the treated PE particles.

| | Atomic % | Atomic % | Atomic % |
|---|---|---|---|
| Sample | C—O—C/C—OH | C═O | COOH |
| Treated PE | 8.1 + 1.0 | 3.8 + 0.5 | 6.3 + 0.8 |
| Particles | | | |

### Concrete Analysis

### Plastic Particles as a Natural Aggregate Replacement

Formulated plastic particles were incorporated into concrete (10%, vol. %) where the compressional strength of concrete produced from the untreated plastic was compared to that of the concrete produced from the plasma treated plastic. A variety of chemical functionalities were used, and the treated class of plastic particles were subject to an initial plasma treatment using oxygen gas with the parameters outlined below (Table). After the initial treatment, and whilst still under vacuum, the treated particles were immediately treated using the chemical functionalities (carried by argon gas) with the plasma parameters outlined below (Table). The concrete mix designs used can be seen in Table 16.

TABLE 14
Plasma treatment parameters (initial treatment) for the treatment of a variety
of plastic particles intended to be used as a natural aggregate replacement.

| | Plasma Parameters | | | |
|---|---|---|---|---|
| Plastic | Time | Pressure | Power | Gas Flow Rate |
| PE | 5 mins | 0.1 mbar | 140 W | 100 sccm |
| PU | 5 mins | 0.1 mbar | 140 W | 100 sccm |
| PET | 5 mins | 0.1 mbar | 140 W | 100 sccm |
| PEX | 5 mins | 0.1 mbar | 140 W | 100 sccm |
| SB | 45 mins | 0.1 mbar | 70 W | 100 sccm |

TABLE 15
Plasma treatment parameters (main treatment) for the treatment
of a variety of plastic particle intended to be used
as a natural aggregate replacement.

| | | Plasma Parameters | | | |
|---|---|---|---|---|---|
| | Chemical | | | | Gas Flow |
| Plastic | Functionality | Time | Pressure | Power | Rate |
| PE | AA | 20 mins | 0.1 mbar | 20 W | 50 sccm |
| | EDA | 20 mins | 0.1 mbar | 20 W | 50 sccm |
| PU | AA | 20 mins | 0.1 mbar | 20 W | 50 sccm |
| PET | AA | 20 mins | 0.1 mbar | 20 W | 50 sccm |
| | EDA | 20 mins | 0.1 mbar | 20 W | 50 sccm |
| | DMF | 20 mins | 0.1 mbar | 20 W | 50 sccm |
| | CP | 20 mins | 0.1 mbar | 20 W | 50 sccm |
| PEX | AA | 20 mins | 0.1 mbar | 20 W | 50 sccm |
| | EDA | 20 mins | 0.1 mbar | 20 W | 50 sccm |
| | DMF | 20 mins | 0.1 mbar | 20 W | 50 sccm |
| | CP | 20 mins | 0.1 mbar | 20 W | 50 sccm |
| SB | AA | 15 mins | 0.1 mbar | 20 W | 50 sccm |
| | EDA | 15 mins | 0.1 mbar | 20 W | 50 sccm |
| | DMF | 15 mins | 0.1 mbar | 20 W | 50 sccm |
| | CP | 15 mins | 0.1 mbar | 20 W | 50 sccm |

TABLE 16
Concrete mix designs for the production of all concrete cubes
where the plastic was intended to be used as a natural
aggregate replacement.

| | | Sharp | | | | |
|---|---|---|---|---|---|---|
| | Cement | Sand | Gravel | Water | Plastic | Total |
| Plastic | Mass | Mass | Mass | Mass | Mass | Volume |
| PE | 1.62 kg | 4.96 kg | 0 kg | 0.437 kg | 0.29 kg | 3.1 L |
| PU | 1.62 kg | 4.96 kg | 0 kg | 0.437 kg | 0.35 kg | 3.1 L |
| PET | 1.62 kg | 4.96 kg | 0 kg | 0.437 kg | 0.45 kg | 3.1 L |
| PEX | 1.62 kg | 4.96 kg | 0 kg | 0.437 kg | 0.35 kg | 3.1 L |
| SB | 1.62 kg | 4.96 kg | 0 kg | 0.437 kg | 0.35 kg | 3.1 L |

The compressional strength of the concrete cubes containing the plasma treated plastic particles was measured as a percentage of the corresponding control sample (Error! Reference source not found, 13). i.e. concrete cubes containing PEX particles treated with AA were 52% stronger compared with concrete cubes containing untreated PEX. It can be seen from the graph that plasma treatment of the plastic particles has a significant impact on increasing the compressional strength of concrete.

### Plastic Particles as a Natural Aggregate Replacement (High Power)

Formulated plastic particles (PE and PS) were incorporated into concrete (12%, vol %) where the compressional strength of concrete produced from the untreated plastic was compared to that of the concrete produced from the plasma treated plastic. AA was used for the plasma treatment, with the parameters outlined below (Table 17). The concrete mix designs used can be seen in Table 18. Again, the compressional strength of the concrete cubes containing the plasma treated plastic particles was measured as a percentage of the corresponding control sample, however, this time the compressional strength was measured after 3, 7 and 28 days (Table 16).

TABLE 17
Plasma treatment parameters for the treatment of a variety
of plastic particles intended to be used as a
natural aggregate replacement (high power).

| | | Plasma Parameters | | | |
|---|---|---|---|---|---|
| | Chemical | | | | Gas Flow |
| Plastic | Functionality | Time | Pressure | Power | Rate |
| PE | Carboxylic | 20 mins | 0.7 mbar | 200 W | 50 sccm |
| | Acid | | | | |
| PS | Carboxylic | 20 mins | 0.7 mbar | 200 W | 50 sccm |
| | Acid | | | | |

TABLE 18
Concrete mix designs for the production of all concrete cubes
where the plastic was intended to be used as a
natural aggregate replacement (high power).

| | | Sharp | | | | |
|---|---|---|---|---|---|---|
| | Cement | Sand | Gravel | Water | Plastic | Total |
| Plastic | Mass | Mass | Mass | Mass | Mass | Volume |
| PE | 8.00 kg | 19.81 kg | 0 kg | 3.04 kg | 1.60 kg | 14.6 L |
| PS | 8.00 kg | 19.81 kg | 0 kg | 3.04 kg | 1.90 kg | 14.6 L |

The compressional strength of the concrete cubes containing the plasma treated plastic particles was measured as a percentage of the corresponding control sample (Error! Reference source not found. 14). It can be seen from the graph that plasma treatment of the plastic particles has a significant impact on increasing the compressional strength of concrete for both PE and PS.

### Plastic Particles as an Additive in Concrete

Formulated PE plastic particles were incorporated into concrete as an additive (0.0004-0.002%, vol. %) where the compressional strength of concrete produced from no inclusion of plastic was compared to that of the concrete produced from the plasma treated plastic. PE particles were treated with AA with the plasma parameters outlined below (Table 19). The concrete mix designs used can be seen in Table 20.

TABLE 19
Plasma treatment parameters for the treatment of PE plastic with AA where
the plastic was intended as a concrete additive.

| Treated PE | | | | | |
|---|---|---|---|---|---|
| Additive | | Plasma Parameters | | | |
| (wt. % of | Chemical | | | | Gas Flow |
| cement) | Functionality | Time | Pressure | Power | Rate |
| 0.1 | AA | 60 mins | 0.1 mbar | 140 W | 100 sccm |
| 0.25 | AA | 60 mins | 0.1 mbar | 140 W | 100 sccm |
| 0.5 | AA | 60 mins | 0.1 mbar | 140 W | 100 sccm |

TABLE 20
Concrete mix designs used in the production of all concrete cubes
where the plastic was intended as a concrete additive.

| Treated PE | | | | | | |
|---|---|---|---|---|---|---|
| Additive | | Sharp | | | | |
| (wt. % of | Cement | Sand | Gravel | Water | Plastic | Total |
| cement) | Mass | Mass | Mass | Mass | Mass | Volume |
| 0 | 1.70 kg | 1.68 kg | 4.30 kg | 0.50 kg | 0 g | 3.3 L |
| 0.1 | 4.70 kg | 4.65 kg | 11.85 kg | 1.39 kg | 4.70 g | 9.1 L |
| 0.25 | 4.70 kg | 4.65 kg | 11.85 kg | 1.39 kg | 11.80 g | 9.1 L |
| 0.5 | 4.70 kg | 4.65 kg | 11.85 kg | 1.39 kg | 23.50 g | 9.1 L |

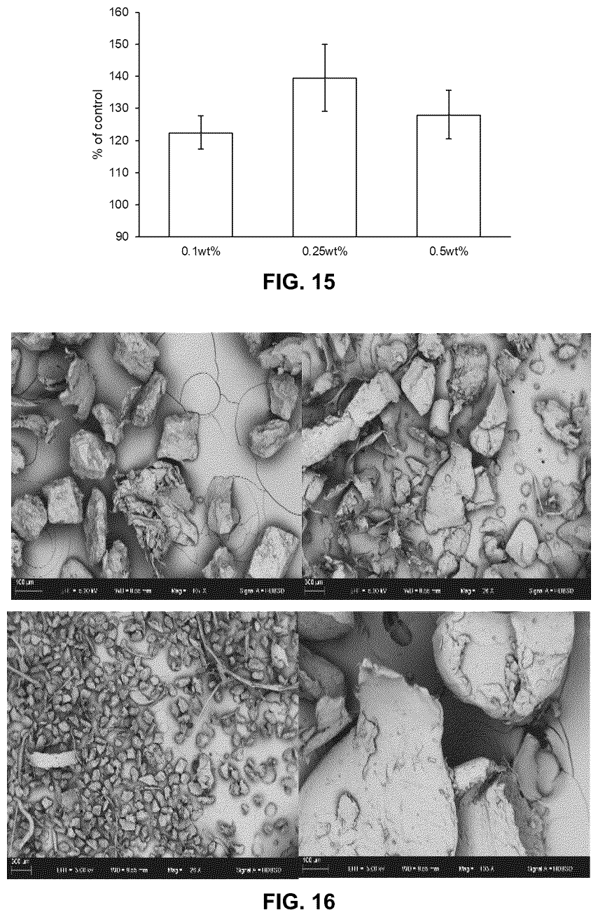

The compressional strength (after 24 hours) of the concrete cubes produced with the inclusion of the plastic particles was compared with the compressional strength after 24 hours of concrete without plastic (control). The compressional strength of the concrete cubes containing the treated plastic additive was measured as a percentage of the corresponding control sample. i.e. concrete containing 0.25 wt % treated PE was 40% stronger than concrete containing no plastic additive. It can be seen from the graph that concrete made with the plastic particles is stronger over all PE weight percentages (FIG. 15).

### Plasma Treatment of Plastic-Cement Mixes

PE plastic particles (4-10 mm) were contacted with cement (5 wt. % of plastic) before plasma treatment with AA (C-PE). PE plastic particles were subjected to an initial plasma treatment using oxygen gas with the parameters outlined below (Table 21). After the initial treatment, and whilst still under vacuum, the treated particles were immediately treated using AA (carried by argon gas) with the plasma parameters outlined below (Table 22). The concrete mix designs used can be seen in Table 23.

TABLE 21
Plasma treatment parameters (initial treatment) for the
treatment of PE plastic particles where the plastic was
contacted with cement prior to concrete production.

| | Plasma Parameters | | | |
|---|---|---|---|---|
| Plastic | Time | Pressure | Power | Gas Flow Rate |
| C-PE | 5 mins | 0.1 mbar | 140 W | 100 sccm |

TABLE 22
Plasma treatment parameters (main treatment) for the treatment
of PE plastic particles with AA where the plastic was contacted
with cement prior to concrete production.

| | Plasma Parameters | | | |
|---|---|---|---|---|
| Plastic | Time | Pressure | Power | Gas Flow Rate |
| C-PE | 20 mins | 0.1 mbar | 20 W | 50 sccm |

TABLE 23
Concrete mix designs used in the production of all concrete
cubes 0where the plastic was contacted with cement
prior to concrete production.

| | | Sharp | | | | |
|---|---|---|---|---|---|---|
| | Cement | Sand | Gravel | Water | Plastic | Total |
| Plastic | Mass | Mass | Mass | Mass | Mass | Volume |
| C-PE | 1.62 kg | 4.96 kg | 0 kg | 0.44 kg | 0.19 kg | 3 L |
| PE | 1.62 kg | 4.96 kg | 0 kg | 0.44 kg | 0.19 kg | 3 L |

### Compressional Strength

The compressional strength (after 24 hours) of the concrete cubes produced with the inclusion of the plasma treated plastic particles (7%, vol. %) contacted with cement during treatment was compared to the compressional strength (after 24 hours) with untreated plastic (control).
The compressional strength of the concrete cubes containing the additive was 142%±19% (% of control). This means concrete containing the plastic particles contacted with cement during plasma treatment was 42% stronger after 24 hours.

### Appendix

All modal sizes were calculated using the following equation:

$$Modal Size = L + \frac{( {f}_{m} - {f}_{1} ) \times h}{( {f}_{m} - {f}_{1} ) + ( {f}_{m} + {f}_{2} )}$$

Where L is the lower limit of the modal class, fₘ is the frequency of the modal class, f₁ frequency of class preceding the modal class, f₂ is frequency of class succeeding the modal class, h is the width of the modal class.
Modal sizes of sharp sand builders sand and plastering sand:

| | Volume Ratios | | | | Modal |
|---|---|---|---|---|---|
| | | 0.25- | 0.50- | 2.00- | size |
| Type | <0.25 mm | 0.50 mm | 2.00 mm | 4.00 mm | mm |
| Sharp Sand | 15.51 | 43.19 | 24.06 | 17.25 | 0.4 |
| | Volume Ratios | | | | Modal |
| | 0.063-0.125 | 0.125- | 0.50- | 2.00- | size |
| Type | mm | 0.5 mm | 2.00 mm | 4.00 mm | mm |
| Builders Sand | 11 | 60 | 27 | 2 | 0.35 |
| Plastering Sand | 12 | 63 | 23 | 2 | 0.34 |

### Example 3: Dissolution PE Testing

### Materials

PE-C (control sample of polyethylene), PE-T (electron beam treated sample of polyethylene), ACS reagent grade xylenes (≥99.9%, Sigma Aldrich UK), and analytical grade methanol (≥99.9%, Fisher Scientific UK) were all used as supplied.

### Experimental

PE-C (0.5011 g) and PE-T (0.4330 g) were each placed into a separate 50 mL round bottom flask before 10 mL of xylenes were added to each flask and a condenser attached (sealed using H-grease). The solutions were then placed in an oil bath heater (set at 150° C.) and left to stir for 21.5 hrs.
After 21.5 hrs, the round bottom flasks were removed from the oil bath and it could be seen that PE-C had completely dissolved while PE-T had only partial dissolved. This was evidenced by a translucent sheet of PE-T still being present after 21.5 hrs of stirring, which was easily separated from the solution using tweezers and worked up separately so that the dissolved and undissolved PE-T could be weighed.

### Results

| | PE-C | | PE-T | |
|---|---|---|---|---|
| Initial mass of PE | 0.50 | g | 0.43 | g |
| Mass of dissolved PE recollected | 0.51 | g | 0.35 | g |
| Mass of undissolved PE recollected | 0 | g | 0.0882 | g |

| | | |
|---|---|---|
| Percentage of PE undissolved | 0% | 20% |

The results support cross-linking in the PE-T particles (those treated with an electron beam).

1. A method of making an aggregate comprising plastics particles having sizes of about 0.1 μm to about 1 cm, the method comprising treating a first plurality of plastics particles with a low-pressure plasma and/or an electron beam to provide treated particles, wherein the plasma comprises ions formed from any one selected from the group consisting of a carboxylic acid, ester, aldehyde, amide, ketone, epoxide, and a combination of two or more thereof.

2. The method of claim 1, wherein the first plurality of particles are of different sizes and/or treated particles of different sizes are contacted with one another.

3. The method of claim 2, wherein the first plurality of particles are of different sizes ; and the method further comprises separating a second plurality of plastics particles to provide separated particles, some of which are combined to provide the first plurality of particles of different sizes.

4-8. (canceled)

9. The method of claim 1, wherein the treating comprises treating with the low-pressure plasma.

10. The method of claim 9, wherein the low-pressure plasma reacts with the particles to form pendant hydrophilic groups.

11. The method of claim 1, wherein the plasma comprises ions formed from precursors that are liquid at a pressure of atmospheric pressure and a temperature of 20° C.

12-14. (canceled)

15. The method of claim 1, wherein the plasma comprises ions formed from a carboxylic acid.

16. The method of claim 15, wherein the carboxylic acid is acetic acid.

17. The method of claim 1 wherein the low-pressure plasma is at a pressure selected from the group consisting of about 0.001 mbar (0.1 Pa) to about 500 mbar (50 kPa), about 0.001 mbar (0.1 Pa) to about 300 mbar (30 kPa), about 0.01 mbar (10 Pa) to about 100 mbar (10 kPa), and about 0.01 mbar (10 Pa) to about 10 mbar (1 kPa).

18. The method of claim 1 further comprising contacting the first plurality of particles with cement before the treating and/or contacting the treated particles with water.

19. (canceled)

20. The method of claim 1, wherein the modal size of the particles of the aggregate is selected from the group consisting of about 60 μm to about 2 mm, about 60 μm to about 1 mm, about 120 μm to about 1 mm, about 120 μm to about 0.8 mm, and of about 120 μm to about 0.7 mm.

21-24. (canceled)

25. The method of claim 1 wherein the particles of the first plurality comprise a thermoplastic polymer and/or a thermosetting polymer.

26. The method of claim 1, wherein the particles of the first plurality comprise one selected from the group consisting of polyethylene, polypropylene, polyurethane, polyisocyanurate, polyepoxide, polyester resin, polysiloxane, styrene butadiene, polyethylene terephthalate, polybutylene terephthalate, polyvinylchloride, polycarbonate, polystyrene, ethyl vinyl acetate, acrylonitrile butadiene styrene, and a combination of two or more thereof.

27-28. (canceled)

29. The method of claim 1 wherein the particles of the first plurality comprise one type of polymer.

30. (canceled)

31. An aggregate comprising plastics particles of about 0.1 μm to about 1 cm, wherein at least some particles of the aggregate comprise surfaces comprising pendant groups selected from the group consisting of carboxyl, alkoxy, hydroxyl, amino, imido alkylidene, ester, aldehydo, acyl, amido, keto, epoxy, cyano, peroxide groups and a combination of two or more, wherein the at least some particles have been treated with a) an electron beam, or b) low-pressure plasma, wherein the aggregate further comprises cement.

32. The aggregate of claim 31, wherein the pendant groups are selected from the group consisting carboxyl, ester, aldehydo, amino, amido, keto, peroxide groups and a combination of two or more.

33-34. (canceled)

35. The aggregate of claim 31, wherein at least some particles of the aggregate that have been treated with an electron beam comprise cross-linked surfaces.

36. The aggregate of claim 31, wherein at least some particles of the aggregate do not express a glass transition temperature.

37. (canceled)

38. The aggregate of claim 31, wherein the modal size of the particles of the aggregate is selected from the group consisting of about 60 μm to about 2 mm, about 60 μm to about 1 mm, about 120 μm to about 1 mm, about 120 μm to about 0.8 μm, about 120 μm to about 0.7 mm, about 0.3 mm to about 0.6 mm, about 1.4 mm to about 3 mm, about 0.5 mm to about 4 mm, 0.75 mm to about 3.75 mm, 1 mm to about 3.5 mm, or about 1.25 mm to about 3.25 mm, about 0.1 μm to about 700 μm, about 1 μm to about 700 μm, about 5 μm to about 700 μm, about 5 μm to about 700 μm, about 20 μm to about 600 μm, and about 20 μm to about 500 μm.

39-44. (canceled)

45. The aggregate of claim 31, wherein the particles of the aggregate comprise any one selected from the group consisting of polyethylene, polypropylene, polyurethane, polyepoxide, polyester resin, polysiloxane, styrene butadiene, polyethylene terephthalate, polybutylene terephthalate, polyvinylchloride, polycarbonate, polystyrene, ethyl vinyl acetate, and acrylonitrile butadiene styrene, and a combination of two or more thereof.

46-47. (canceled)

48. The aggregate of claim 31, wherein about 0.1 to about 100% of the at least some particles that have been treated with an electron beam are cross linked as determined by dissolution testing.

49. Concrete comprising the aggregate of claim 31.

50. The concrete of claim 49, wherein the concrete has a sand:aggregate specific volume ratio range selected from the group consisting of about 49:1 to about 0:1, about 8.1:1 to about 0:1, about 49:1 to about 0.1:1, about 8.1:1 to about 0.2:1, about 19:1 to about 0.25:1, about 9:1 to about 0.66:1, about 5.5:1 to about 0.82:1, and about 2.7:1 to about 1:1.

51-60. (canceled)
